(19) United States
(12) Patent Application Publication
(10) Pub. No.: US 2025/0294329 A1
(43) Pub. Date: Sep. 18, 2025

(54) PRE-EMPTIVE VEHICULAR TO PEDESTRIAN DETECTION

(71) Applicant: InterDigital Patent Holdings, Inc., Wilmington (DE)

(72) Inventors: Quang LY, North Wales, PA (US); Catalina MLADIN, Hatboro, PA (US); Dale SEED, Allentown, PA (US); Lu LIU, Conshohocken, PA (US)

(73) Assignee: InterDigital Patent Holdings, Inc., Wilmington (DE)

(21) Appl. No.: 18/862,186

(22) PCT Filed: May 3, 2023
(86) PCT No.: PCT/US2023/020809

§ 371 Date: Nov. 1, 2024

Related U.S. Application Data
(60) Provisional application No. 63/338,511, filed on May 5, 2022.

(51) Int. Cl. H04W 4/40; G08G 1/16; H04W 4/024

(52) U.S. Cl. CPC H04W 4/40; H04W 4/024; G08G 1/16

(57) ABSTRACT

Disclosed herein are methods and systems for pre-emptive vehicular to pedestrian detection. A VAE client may receive a first request from an application client on a UE to enable VRUP services associated with the UE. The VAE client may send a second request to a VAE server to create a V2P policy. The VAE client may receive a first response to the second request indicating the status of the second request, the first response comprising information of the V2P policy that applies to the UE. The VAE client may send a second response to the first request indicating the status of the first request.

### CROSS-REFERENCE TO RELATED APPLICATIONS

This application claims the benefit of U.S. Patent Application No. 63/338,511 filed on May 5, 2022.

### BACKGROUND

This disclosure pertains to the operation of wireless networks such as those described in, for example: 3GPP TS 23.286, Application layer support for Vehicle-to-Everything (V2X) services, Functional architecture and information flows; V17.3.0 (2021-09); 3GPP SP-210956, Study on enhancements to application layer support for V2X services, Phase 2 (2021-09); and 3GPP TR 23.700-64, Study on enhancements to application layer support for V2X services, Phase 2; V0.3.0 (2022-02).

### SUMMARY

Basic Vehicle-to-everything (V2X) services have been defined to enable vehicle to vehicle communications to avoid collisions and offer support for autonomous driving. More advanced V2X services are being added to enable communication between vehicles and pedestrians to provide protection for vulnerable road users. As a result, vehicle to pedestrian (V2P) detection may enable alert warnings and V2P communication configuration well in advance of any potentially dangerous situations to ensure pedestrian safety.

Advanced V2P detection may be utilized as a first defense in overall V2P detection capabilities in the system. Warning alerts and V2P communication configuration may be sent to one of or both vehicular and pedestrian UEs that may be in a path of potential collision to improve pedestrian safety. The advance alert may be used as a preemptive mechanism to ensure safety for pedestrians in a technologically dominant society. For example, users are increasingly distracted with the availability of mobile gaming, social media, video streaming, AR/VR applications, and the like. Similarly, vehicle advances are being introduced to allow for semi and fully autonomous driving, tele-operated driving, and media consumption within vehicles.

For example, a V2X Application Enabler (VAE) client may receive a first request from an application client on a Wireless Transmit/Receive Unit (WRTU) such as a User Equipment (UE) to enable Vulnerable Road User Protection (VRUP) services for the user of the UE. The VAE client may send a second request to a VAE server to create a vehicle to pedestrian (V2P) policy. The second request may comprise information such as the UE identifier, the UE location, an indication for creating a V2P policy, location reporting configuration of the UE, conditions for which to send the UE alerts, V2P communication parameters, temporal constraints for V2P detection, the creation of a VRU zone and whether the zone is dynamic.

The VAE client may further receive a response to the second request indicating the status of the request and information of a V2P policy that applies to the UE, send a response to the first request indicating the status of the VRUP request, and receive a vehicle to pedestrian notification from a VAE server (e.g., speeding car approaching) and send a notification to an application client on the UE. The VAE client may receive a vulnerable road user protection notification from an application on the UE (e.g., user is actively texting . . . and crossing the street) and send application context information to a VAE server.

Similarly, a VAE server may receive a first request from a VAE client on an WRTU, e.g., a UE. The first request may comprise the UE identifier, the UE location, an indication for creating a V2P policy, location reporting configurations of the UE, conditions for which to send the UE alerts, V2P communication parameters, temporal constraints for V2P detection, information regarding the creation of a VRU zone and whether the zone is dynamic.

The VAE server may send a notification to a Vertical Application Specific Server (VASS) to check for authorization of the VAE client request to create a V2P policy, receive a response from the VASS which comprises, for example, authorization information, V2P communication policy and parameters, configuration of location management, and/or a data analytics subscription for the UE. The VAE server next may create a V2P policy to enable V2P detection.

Next the VAE server may send a response to the first request with information from the V2P policy that pertains to the UE, and receive notifications, e.g., of UE mobility, data analytics prediction, and/or application context information. The VAE server may update the VRU zone associated with the V2P policy, and send a notification to a second UE to alert of a potential collision and/or comprise V2P communication parameters for the second UE to communicate directly with the first UE.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

A more detailed understanding may be had from the following description, given by way of example in conjunction with the accompanying drawings.

FIGS. 1A and 1B show a block diagram of an example V2X application layer functional model.

FIGS. 2 through 5 are call flow diagrams.

FIG. 2 shows V2P policy creation at a VAE server.

FIG. 3 shows configuration operations for V2P communication.

FIG. 4 shows V2P detection with a dynamic VRU zone.

FIG. 5 shows V2P detection triggered by data analytics.

FIG. 6 shows an example GUI.

FIG. 7A shows an example communications system.

FIGS. 7B-D are system diagrams of example RANs and core networks.

FIG. 7E shows another example communications system.

FIG. 7F is a block diagram of an example apparatus or device, such as a WTRU.

FIG. 7G is a block diagram of an exemplary computing system.

### DETAILED DESCRIPTION

Table 1 of the Appendix describes many of the acronyms used herein.

A Vehicle-to-Everything (V2X) Application Layer Functional Model may be described herein.

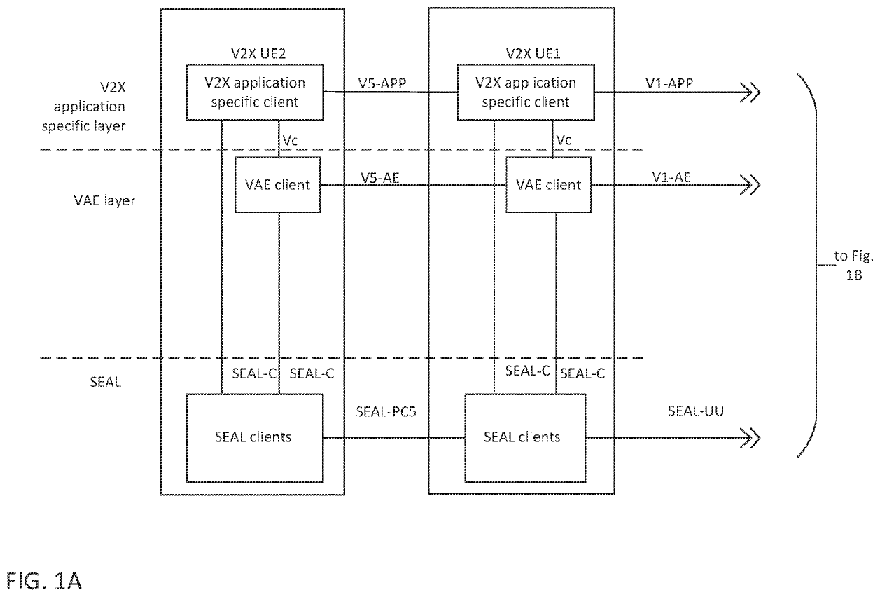

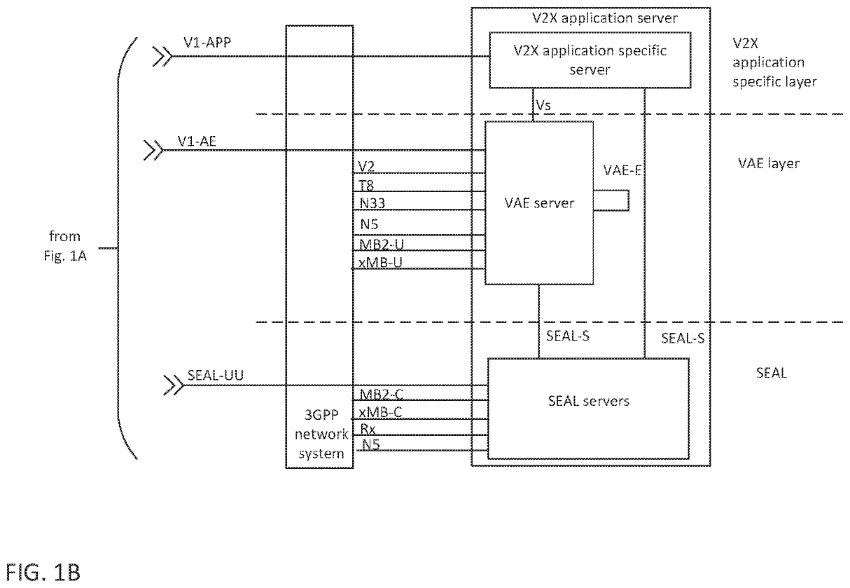

FIGS. 1A and 1B, which are taken from 3GPP TS 23.286, show a Vehicle-to-Everything (V2X) application layer functional model defined in the 3GPP SA6 working group. The functional model supports User Equipment (UE) communications with a 5G network as well as UE-to-UE communications for V2X applications. In addition, UE1 of FIG. 1A may serve as a UE-to-network relay where data traffic from UE2 may be sent to UE1 and relayed to the 5G network.

The V2X Application Enabler (VAE) layer offers common services to the V2X application specific layer and may also utilize the services of the SEAL layer in offering the services. The VAE layer provides services to V2X application specific clients and servers through the Vc and Vs interfaces, respectively. Within the VAE layer, VAE clients may communicate with each other using the V5-AE interface and VAE clients may communicate to VAE servers using the V1-AE interface. VAE clients and servers may use the SEAL-C and SEAL-S interfaces to communicate with the SEAL clients and SEAL servers, respectively.

Within the V2X application servers, both VAE servers and SEAL servers have various interfaces with the 5G network to obtain additional information about the V2X capable UEs. Through these interfaces, the VAE and SEAL servers may have access to policy control functions, multicast and broadcast configuration and operation, location management functions, and available network exposure capabilities. VAE servers may also communicate with other VAE servers.

### Service Enabler Architecture Layer (SEAL) for Verticals

As shown in FIGS. 1A and 1B, the SEAL layer is under the VAE layer and offers additional services that the VAE layer may leverage to support the V2X application specific layer. The SEAL layer provides common, horizontal services that may be utilized by various vertical applications. Some of the common services offered by SEAL are: location management, group management, configuration management, identity management, key, management, and network resource management. SEAL clients on a UE receive user traffic from upper layers such as from the VAE or application specific layers and transport the traffic to a SEAL server using the SEAL-UU interface. When SEAL clients on UEs communicate with each other, the SEAL clients utilize the SEAL-PC5 interface.

### Advanced V2X Services

In Release 18, 3GPP has determined the need to study enhancing application layer support of V2X services that have already been defined in 3GPP TS 23.286 to comprise support for advanced V2X services such as Vehicle to Pedestrian (V2P) communication and Tele-operated Driving (ToD). An analysis of the impact of edge architectures on usage of existing V2X functionalities is another objective of the study, which is captured in 3GPP SP-210956.

Work has begun on the study of adding application layer support for advanced V2X services and is documented in 3GPP TR 23.700-64. It has been proposed as a key issue that the VAE layer may be deployed with Edge Enabler Layer (EEL) in support of advanced V2X services. As such, EEL procedures such as EEC registration, EAS registration and discovery, UE location, Application Content Relocation (ACR) management events, and Application Client (AC) information exposure, may be utilized to support advanced V2X services.

In addition, a definition of Vulnerable Road User (VRU) high risk zones has been proposed. VRU high risk zones may consist of a school bus stop, a portion of a city where there is a lot of pedestrian traffic, a planned parade or festival, or known high accident areas. For these scenarios, a V2X Application Specific Server (VASS) may request to define a VRU zone using location information that is understandable to users, such as an address or GPS coordinates for an area. A VAE server receiving the request may translate the address or GPS coordinates into 5G system location information such as tracking area or cell area identifiers. For example, a government transportation agency may be a VASS that defines known VRU zones for a city and disseminates the information to V2X infrastructure nodes throughout the city via a VAE server.

### Example Challenges

Thus far, work has begun in 3GPP on adding application layer support for advanced V2X services in Release 18. Key issues have been defined for the support of high risk VRU zones and for the support of V2P communications between vehicular and pedestrian UEs. Use case areas identified to be supported by dynamic high risk VRU zones comprise school bus stops and the route of a cyclist. However, there have been no solutions to address such use cases where a VAE client may request the creation of a dynamic VRU zone that tracks the mobility of a UE and adjusts the VRU zone accordingly to provide further protection to the user.

In addition, advance V2P detection in which edge and/or cloud servers assist with providing alerts and V2P communication configuration have not been addressed. The edge or cloud server may utilize UE mobility information at the edge data networks as well as data analytics that may be able to predict UE mobility that may result in potential vehicle to pedestrian collisions. The advance notice alerts may allow time for the vehicular and pedestrian UEs to establish V2P communications with each other and avoid the development of any dangerous situations.

### Example Solutions

V2X Vehicle to Pedestrian (V2P) detection may be used to pre-emptively provide alerts and configuration of V2P communication parameters to vehicular and pedestrian UEs. V2P detection may be categorized into two main scenarios: proximal or advanced notice detection. In proximal V2P detection, the vehicle and pedestrian are close enough to each other and the main communication mechanism may be from direct device-to-device (D2D) communications between the pedestrian UE and the vehicular UE. For advanced notice V2P detection, an edge or cloud application server may assist and provide the V2P detection alert to the vehicular or pedestrian UE in advance of a potential collision when the vehicle and pedestrian are sufficiently distanced from each other to enable such alerts. A V2P policy may be utilized to determine the configuration of VRU zones and V2P communication parameters to provision to the VAE clients of the UEs.

A benefit of advanced notice V2P detection may be the added ability to configure V2P communication parameters between vehicular and pedestrian UEs prior to the development of a potentially dangerous situation. The identification of vehicular and pedestrian UEs may be made in advance to ensure proximal V2P detection is most effective. For example, a VAE server may identify fast moving vehicles entering a VRU zone sooner and alert both pedestrian and vehicular UEs in the VRU zone to use proximal V2P detection earlier to prevent a potential collision. The VAE server may enable proximal V2P detection and alert the affected vehicular and pedestrian UEs. On the other hand, a slower moving vehicle entering a VRU zone may trigger a V2P detection alert later while providing sufficient reaction time for the UEs in the VRU zone.

Note that the term V2P detection as used in this disclosure may represent the detection of a potential collision between a vehicle and a vulnerable pedestrian, bicyclist, motorcyclist, or other user operated vehicle such as a scooter. A resulting warning alert may be sent to both vehicular and pedestrian UEs to indicate the potential of a collision. In addition, V2P detection may also refer to the detection of the potential to provision V2P communication parameters to vehicular and pedestrian UEs to allow the UEs to communicate with each other. Both the warning alerts and the provisioning of V2P communication parameters may be sent together in response to V2P detection.

### V2P Policy

An example of a V2P policy that may be used for V2P detection is shown in Table 2 of the Appendix. The V2P policy may be created during registration between a VAE client and a VAE server or through a separate request made by the VAE client to the VAE server. The V2P policy may c information to enable a VAE server to perform V2P detection to alert vehicular and pedestrian UEs of a potential collision. A VAE client may provide information that may be used to create or modify a V2P policy and a VAE server may obtain information from other entities in the cellular system to create the V2P policy.

For example, a VAE client may provide a UE identifier, UE location, location reporting configuration, supported alert mechanism, temporal constraints for V2P detection, user consent for using application context information, or the like when registering to a VAE server. The VAE server may use the information provided by the UE to create a V2P policy in conjunction with other information the VAE server may gather from other entities in the system. As an example, the VAE server may contact entities in the cellular system, such as a SEAL server, an Edge Enabler Server (EES), the 5G core network, and a VASS, to obtain additional information for use in creating the V2P policy. The VAE server may obtain such information about other UEs in the proximity of the original UE and their location relative to the original UE. Furthermore, the VAE server may discover application servers that may provide V2X services to the original UE and may be able to define VRU zones with or without a VASS. The VAE server may even utilize access to analytics capabilities, either within the application, network, or management domains to define the VRU zones. Finally, the VAE server may be configured or provisioned with local policies of a default VRU zone and of a certain size that are defined automatically for newly created V2P policy.

Table 2 of the Appendix shows a V2P Policy Example.

Within a V2P policy, a Policy identifier is used to identify the V2P policy, and the identifier may be used to modify an existing policy such as to add or remove one or more UE identifiers. An expiration time may also be set to indicate when the V2P policy expires. The V2P status may indicate whether the V2P policy is enabled for V2P detection, and the UE identifiers may consist of a list of UE identifiers and/or group identifiers for a group of UEs. The UE identifiers may be used by a VAE server upon V2P detection of a potential collision to notify the UEs or group of UEs for advance notice scenarios. For proximal scenarios, a VAE server may notify the impacted UEs to provide information to the UEs for enabling direct D2D communications between the UEs. For example, the VAE server may provide two UEs with contact information of the other UE, the D2D communication parameters, and other information to enable V2P detection on the UEs.

One or more VRU zones may be defined for the V2P policy to enable V2P detection. The VRU zones may be created automatically by a VAE server if the server is configured with necessary information to be able to define the VRU zones. For example, a VAE server may be configured to automatically create a VRU zone using the UE's location or a nearby location of a road intersection as the center point of the zone and extending a certain distance from the center. Alternatively, a VASS may make a request to the VAE server to define one or more VRU zones. The VASS in this alternative method may be operated by a city's department of transportation where they define VRU zones to comprise busy intersections, high risk or accident-prone locations, tourist locations, or the like. Finally, a UE may also request the creation of VRU zone.

A VRU zone may be dynamic in nature where the zone changes according to the mobility of a UE, such as that of the locations of school bus stops, the route of a runner, cyclist, or motorcyclist, or a group of tourists participating in a walking tour of various, connected neighborhoods. The Dynamic zone indicator informs the VAE server to adjust the VRU zone based on the location updates provided by the mobile UE. As the mobile UE moves, the VAE server may receive direct messages from the UE to update the VRU zone. Alternatively, the VAE server may receive UE location updates from a SEAL server, an EES, or even from the 5GS. The VAE server may periodically update the VRU zone to detect for potentially dangerous situations and provide the corresponding notifications.

The V2X profile indicator of a UE may also be provided to a VAE server to identify the type of V2X user, for example whether it is a pedestrian, a bicyclist, a motorcyclist, or a vehicle. The V2X profile may be used by the VAE server to determine the capability of the UE to send and receive V2X messages as well as the level of vulnerability of the user.

An important aspect of V2P detection is when to send notification alerts to both vehicular and pedestrian UEs. The scenarios with which to send the alert notifications may be captured in the Notification alert conditions parameter of a V2P policy. The conditions for sending notification alerts may be provided by a UE, a VASS or other application specific server, or a configured policy within the VAE server. The conditions may be specified in relation to the presence of a UE within a VRU zone or at a certain distance from the VRU zone. For example, a condition may be such that the presence of a UE within a VRU zone may activate a proximal V2P detection notification in which the identified UE is notified to enable V2P detection on the UE and is provided with information about other UEs to enable D2D communications. As another example, the presence of a vehicular UE outside a VRU zone but within a certain distance of the VRU zone may trigger a notification to the vehicular UE to be aware of upcoming pedestrians, to adjust the route or travelling speed of the vehicle, or to initiate or establish V2P communication with pedestrian UEs. The last example provides an example of advanced notice V2P detection, and the resulting notification may allow a vehicle time to establish secure V2P communications with pedestrian UEs in the VRU zone.

The Notification alert conditions parameter may have various components that are defined for a certain condition for sending notification alerts within the V2P policy. One component may be indicated whether the condition applies to proximal or advanced notice V2P detection scenarios. In some cases, both proximal and advanced notice scenarios may be enabled for the same condition, e.g., if the VRU zone is sufficiently large. Another component of the Notification alert conditions parameter may be the distance a UE is in relation to the VRU zone. This component may comprise one or more distances from a VRU zone that may trigger notification alerts. As an example, distances of 1, 2, and 5 kms may trigger advance notice notification alert while a distance of 0.5 km may trigger both advance notice and proximal notification alerts.

When a notification alert condition triggers, the VAE server may use the V2P communication parameters to determine how to configure V2P communication for the UE. Note that the configured mechanism may require the VAE server to set up communication resources after the V2P policy is activated. For example, if the communication mechanism is to use multicast, a multicast group may need to be configured prior to the activation of V2P detection to ensure the communication mechanism is available to send alert messages when a V2P detection is triggered. Similarly, unicast, groupcast, and broadcast configurations may also require configurations for V2P communication prior to activating V2P detection. The VAE server may configure network resources to support the desired communication mechanism at a time associated with creating the V2P policy or the VAE server may configure the network resources after creating the V2P policy. The VAE server may configure the network resources before activating the V2P detection.

For V2P detection to work properly, it is important that a UE's location information is available to the VAE server. The Location reporting configuration parameter specifies the frequency with which the UE may provide location information to the network and/or to the VAE server. This parameter may be provided by the UE when requesting the creation of a V2P policy and the parameter value may be determined by the power source of the UE. For example, a vehicular UE may be able to provide more frequent location information due to a stable and readily available power source while a pedestrian UE may provide less frequent location information due to having a less determinant power source such as a smaller battery that may fluctuate throughout a day without a chance to recharge. The VAE server may obtain location information from different sources, such as from an EES using the UE Location API, from a SEAL server using the SEAL location APIs, or even from the 5GS if the VAE server has access. The VAE server may also use predictive location information provided by data analytics. The Location reporting configuration parameter may also be configured by the VAE server either to override the value provided by a UE or due to a missing value for the parameter. One scenario where a VAE server may override a frequency value provided by a UE is if there is a minimum frequency that the V2P detection requires.

The Temporal constraints parameter may be utilized by UEs to specify time durations that may require V2P detection. The time duration may represent, for example, a regular, periodic schedule in which the UE is at a certain VRU zone such as the daily commute of a user. The Temporal constraints parameter may also be specified to be location specific that may trigger the activation of V2P detection. Using the same example of the daily commute of a user, the Temporal constraints parameter may be configured to specific locations of the user's commute that would trigger V2P detection. In yet other ways to configure the Temporal constraints parameter are defining fixed times or by on demand requests for one time or infrequent scenarios where a UE would be in a VRU zone. Examples for these configurations are the planning of a city parade, a tourist visiting a high traffic VRU zone, or an impromptu cyclist training event.

A component of the V2P policy that may have applicably to edge computing is the Application server identifiers parameter. This parameter may be managed by VAE servers to assist with making application context relocation decisions to maintain service continuity for the UE as it moves from one edge application server to another edge application server. A VAE server may utilize the ACR management events capability exposure provided by edge enabler servers to manage the list of application servers. When coupled with UE mobility information, a VAE server may be able to select an application server from the list of target edge application servers provided from the ACR monitoring event exposure returned by the EES for use as the target edge application server in the application context relocation procedure. In addition, the EAS discovery procedure may be enhanced to allow an EAS to discover other EASs to assist with ACR procedure. For example, a VAE server may provide a discovery filter to discover other VAE servers that supports V2P detection and use the resulting list of EASs as input for the ACR procedure. Note that a VAE server is considered an EAS in the context of edge computing architecture.

The Battery information parameter may provide information about the device type of the UE by indicating the battery size or capacity and operating mode of the device. This information may inform the VAE server how frequent the UE is able to receive V2X messages. Other information may only be available on the UE, such as the battery level and discharge rate. The VAE client on the UE may use this information to determine the frequency of transmission and reception in V2P communication with other UEs.

An aspect that may help the V2P detection process is the sharing of the identifier or type of application that is actively running on a UE. Additional application context information regarding the user of an application may also be shared. For example, if a user is typing input into an application (e.g., texting), the user may be looking down at the screen (e.g., video chatting), or the user is wearing headphones and listening to music. Other examples may comprise a user distracted by an immersive experience with AR/VR glasses, watching a video, approaching or crossing a crosswalk, or having a conversation with a friend. The sharing of this information may enable the V2P detection to determine the attentiveness of a user or driver that may be incorporated into data analytics to improve V2P detection. A VAE client may provide an indication for sharing the actively running application and user attentiveness information when entering a VRU zone or a VAE server may request if a VAE client would like to share such information. One example where such information may be useful comprises a user on a call when the UE moves into a VRU zone and the user's attention may be distracted. Another example comprises a user watching a video or playing a game and may be distracted.

Thus far, the information of a V2P policy listed in Table 2 of the Appendix have been described individually and as a separate parameter. It is noted that certain parameters may be grouped together as part of a larger informational element. For example, the parameters UE identifiers, V2X profile, Notification alert conditions, V2P communication parameters, Location reporting configuration, Temporal constraints, and Battery information may be grouped together to represent V2P configuration for a certain UE or a group of UEs.

The V2P policy may also comprise information about opportunistic critical information delivery conditions. This information is used to enable services using V2P detection and communications to also enable dissemination of critical information on a very granular basis, within limited and dynamically defined areas. For example, this mechanism may enable localized alarms regarding flash flood conditions, or the like. The opportunistic critical information delivery conditions information defines under which conditions such information should be forwarded, the types of information to be trusted, the types of information of interest to be forwarded, or the like.

Note that the information in the V2P policy may be shared among all interested parties, such as VAE servers and vehicular and pedestrian UEs. As a result, V2P detection may also be performed by VAE servers as well as by vehicular and pedestrian UEs. For example, a V2P policy for a particular VRU zone may be disseminated by the VAE server to all UEs within the VRU zone. Once the V2P policy information is provisioned to a UE in the VRU zone, V2P detection may be performed by the UE. If V2P communication parameters are also provided to the UE, the UE is also able to communicate with other UEs in the VRU zone.

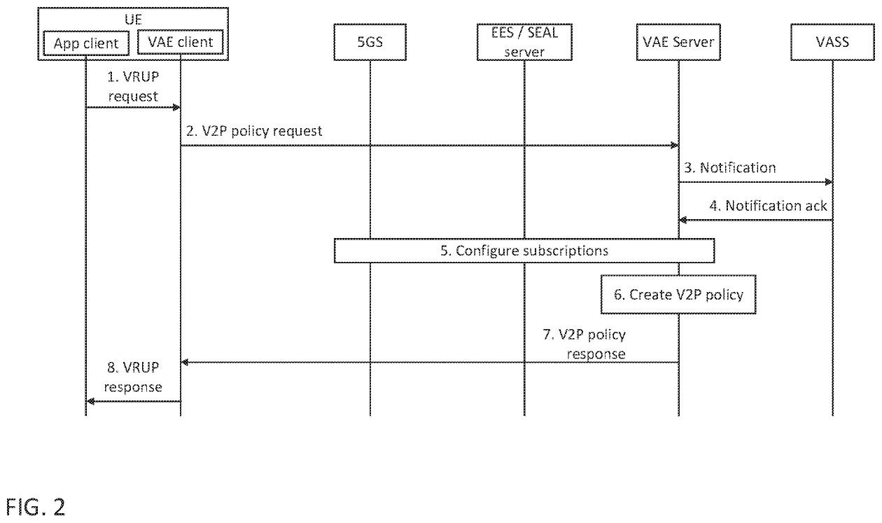

As previously stated, a VAE client may request to create or update a V2P policy during registration to a VAE server or in a separate request. FIG. 2 shows an example procedure where a VAE client makes a separate V2P policy request to a VAE server and in response, the VAE server creates a V2P policy and provides the policy to the VAE client. A VASS, VAE server, EES, and/or a SEAL server may have a registration relationship with each other. For example, a VASS may have discovered and registered to a VAE server that provides V2P detection capability. A VAE server may also have discovered and registered to a SEAL or an EES, or both. It is also assumed that security mechanisms have been established so that each entity may securely communicate with each other. If appropriate, subscriptions may have already been requested for receiving notifications for certain events that may impact V2P detection, such as the creation or modification of V2P policy and UE mobility information. The subscription may be between a VASS and a VAE server or between a VAE server and one or more entities that provide UE location information, such as an EES, a SEAL server, or the 5GS. In addition, the VAE client may also have a registration with the VAE server or has discovered the VAE server and have been provisioned with information to communicate with the VAE server. Similarly, the UE and the application servers may securely communicate with the 5G core network.

Step 1 of FIG. 2: An application client on a UE makes a request for Vulnerable Road User Protection (VRUP) service for the user of the UE. The request may comprise a destination location for which the user is travelling to. The destination location may be a street address or a GPS coordinate of the destination. Alternatively, the route of the user may be sent in the request, for example, from the output of a navigation app. Note that other application context information such as the opening or closing of applications, current and previous application activities, user activities, user consent for using application context information, or the like. may be provided from the application client to the VAE layer to assist with making determination for V2P policy request. Furthermore, the request may comprise information from Table 2 of the Appendix.

Step 2: A VAE client on the UE sends a message to a VAE server to request the creation or update of a V2P policy that may be use for V2P detection. The VAE client request may comprise the UE identifier, the UE location and destination location, an indication for creating a V2P policy, location reporting configuration of the UE, conditions for which to send the UE alerts, the mechanisms the UE supports for V2P communication, user consent for using application context information, and other information as listed in Table 2 of the Appendix. The VAE client may also request the creation or update of a VRU zone and specify whether the zone is dynamic. For dynamic VRU zone, the UE may need to provide location updates for the VAE server to adjust the VRU zone according to the new UE location.

Step 3: The VAE server may send a notification to a VASS indicating the UE's request for creating or updating a V2P policy. The notification may comprise the information provided by the VAE client in step 2.

Step 4: The VASS may return an acknowledgement to the notification and if necessary, the VASS may provide authorization for the UE to create or update the V2P policy. In the response, the VASS may also provide information for the V2P policy such as an expiration time for the policy and one of more VRU zones near the proximity of the UE. The VRU zones may be incorporated into the V2P policy by the VAE server to support V2P detection. The VASS may also provision V2P communication parameters for the UE, including policy and parameter provisioning that may be required to enable V2P communication.

Step 5: The VAE server may make subscription requests to one or more of the following entities: an EES, a SEAL server, or entities in the 5GS. For the case of subscription to an EES, the VAE server may first discover one or more EESs that may serve the UE based on the UE location and select the EES that may best serve the UE. The VAE server may use the EES capability exposure to EAS to assist with managing V2P policy management due to UE mobility. For example, the VAE server may use the service continuity planning capability of the EES to enable application context relocation of the V2P policy. If data analytics is available, the VAE server may also subscribe to receive analytics from the network or from application analytics servers.

Step 6: The VAE server creates or updates a V2P policy upon obtaining all necessary information by the VAE server. An example of the information that may be in the V2P policy is shown in Table 2 of the Appendix. Depending on the V2P communication parameters specified in the V2P policy, it may be necessary for the VAE server to configure network resources to enable for example groupcast, multicast, or broadcast communications for V2P communication, prior to enabling V2P detection. The VAE server may configure the network resources during Step 6. The VAE server may configure the network resources after Step 6. The VAE server may activate V2P detection in response to configuring the network resources. In addition, the VAE server may also enable D2D communications between the impacted UEs. Enabling D2D communications may require one or more of authentication, authorization, and other security mechanisms to enable the D2D communications between the UEs.

Step 7: The VAE server may send the information from the V2P policy in a response message to the VAE client with the status for the request and an indication for the VAE client to provide application context information. The VAE server may also activate the V2P detection feature during Step 7 or, for example, the VAE server may activate the V2P detection feature after network resources have been configured to support the appropriate V2P communication mechanism(s).

Step 8: The VAE client may send a response message to the application client with the status for the VRUP request.

### Vehicle to Pedestrian Detection

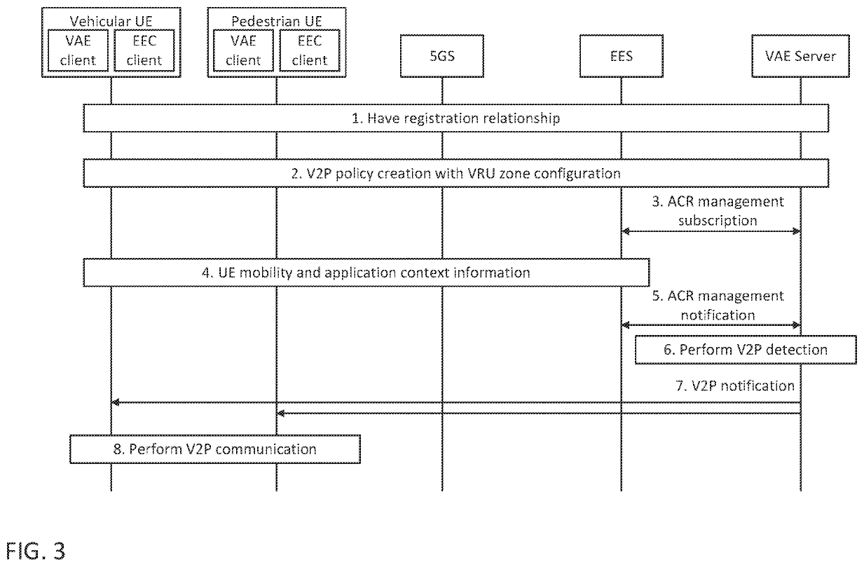

When a VAE server has obtained information for the V2P policy and has activated the V2P detection, the VAE server may monitor location information of UEs entering and exiting the VRU zone. In response to UE mobility information, the VAE server may provide alerts to vehicular or pedestrian UEs and configured and enabled V2P communications between the UEs. FIG. 3 shows an example procedure where a VAE server utilizes the EES capability exposure function to obtain UE mobility information to trigger V2P detection. The VAE server alerts and configures the vehicular and pedestrian UEs for V2P communications.

Step 1 of FIG. 3: A VAE client and an Edge Enabler Client on the UEs have discovered and registered to the appropriate VAE server and Edge Enabler Server, respectively. In addition, the VAE server has discovered and registered to an EES to obtain edge enabler services.

Step 2: The vehicular and pedestrian UEs request to create or modify a V2P policy with the VAE server as previously described. At this time, one or more VRU zones may also be defined for the V2P policy and V2P detection is enabled. Note that as part of V2P policy creation, the VAE server and EES may subscribe to receive notifications for UE mobility. Subscriptions may be made to receive data analytics predictions if they are available, either from the 5G core network or at an application data analytics enabler layer. Another aspect of V2P policy creation or update involving proximal V2P detection is the enabling of secure D2D communications between impacted UEs, which may require authentication, authorization, and security provisioning procedures to enable D2D communications. Finally, and as previously noted, application context information such as user activity, current and previously active applications, opening and closing of applications, routing information from navigation app, user consent for using user application context information, or the like. may be provided by application clients to the VAE layer to assist with making V2P decisions, whether it is for V2P policy creation, update, or detection.

Step 3: The VAE server makes a subscription to the EES to be notified of ACR management events and the EES returns a response to the subscription request.

Step 4: UE mobility notifications are sent for the corresponding subscriptions. UE mobility information may be gathered by the 5G core network or provided by the VAE client or the EEC on the UE to the VAE server. Network data analytics on UE mobility may be active and predictions of UE mobility toward or into the VRU zone may be made. If data analytics are available, the analytics prediction output may also be used. For example, the data analytics prediction may indicate that a vehicular UE is moving at a fast speed towards pedestrian UE(s) in the VRU zone. In addition, application context information may be provided by the application client to the VAE layer to assist with V2P detection.

Step 5: The EES sends an ACR management notification to the VAE server and the VAE server acknowledges the notification.

Step 6: Using the UE mobility information, data analytics prediction, or application context information, the VAE server evaluates the V2P policy and performs V2P detection. The VAE server decides based on the locations of the vehicular and pedestrian UEs on which type of notification alerts to send to each UE. The determination may also be made based on other information defined/indicated in the V2P policy, such as the attentiveness of the user or other application context information. In one example, advance notice V2P alerts may be sent to both the vehicular and pedestrian UEs if the distance between the UEs is significantly large. The advance notice alert allows vehicular UEs time to establish Layer-2 link and any required security establishment with pedestrian UEs if unicast is enabled. In another example, a V2P alert may be sent to configure the vehicular UE for sending groupcast messages to pedestrian UEs in the VRU zone.

Step 7: The VAE server may use the V2P communication parameters configured in the V2P policy to configure and enable V2P communication between UEs. Note that the V2P communication parameters may be configured to use unicast, groupcast, multicast, broadcast, or any combination thereof. The alert message may comprise policy and parameter provisioning for a UE such as an authorization policy, radio communication parameters, parameters for the selected access type (e.g. network or direct communication), V2X identifiers, identifiers for the appropriate V2X communication (e.g. destination Layer2-ID), identification of a VRU cluster head responsible for transmitting a warning message, information for mode of communication, network protocol to use, indication of device type, communication schedule, V2X service identifier and message type, transmission profile, and QoS parameters. If groupcast communication is specified for use, a range value may also be provided. Note that information contained in the V2P policy may also be sent to the UE.

Step 8: Using the information provided in step 8, the vehicular and/or pedestrian UEs perform V2P communication with other UEs in the VRU zone.

Once the V2P detection has been activated, the VAE server may continually perform V2P detection to account for changes in UE mobility or in response to receiving V2X messages from UEs in a VRU zone. For example, if a pedestrian UE informs the VAE server that its battery is low and the UE is entering sleep or power saving mode, the VAE server may notify a VRU cluster head and in response, the VRU cluster head may send a warning alert to vehicular UEs near the location of the pedestrian UE. The VAE server may determine a VRU cluster head based on the location information obtained for pedestrian UEs in the VRU zone.

The notification shown in step 8 of FIG. 3 may be used to configure UEs in or near the VRU zone for V2P communications. In the case where an advance notice alert is made, the VAE server may provide configuration information to vehicular UEs for enabling V2P communication with pedestrian UEs in the VRU zone. When unicast communication is configured, the early alert may allow the vehicular UE time to establish D2D communications with pedestrian UEs and establish any security credentials to enable secure communications. If the UEs are both within the VRU zone, the VAE server may send a proximal alert where the vehicular UE may be provisioned with multicast, groupcast, or broadcast information to enable more immediate communication.

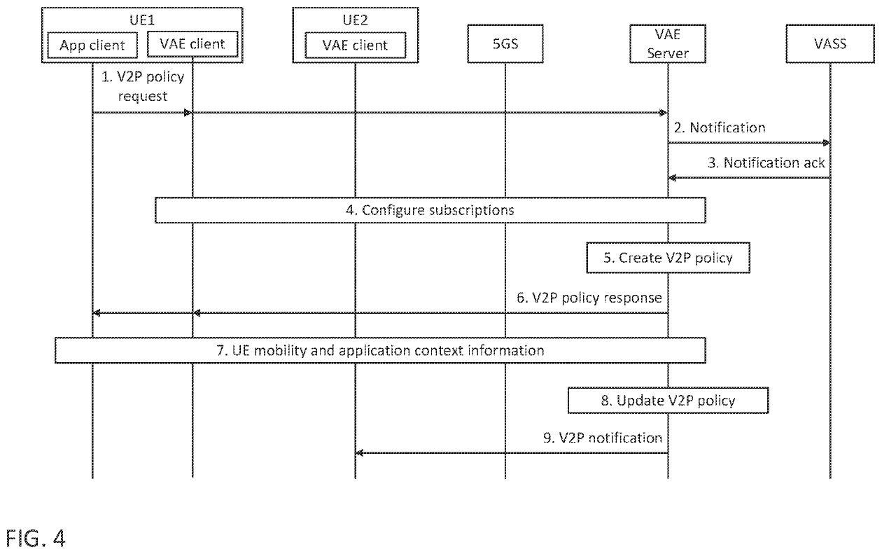

An important feature of the V2P policy is the capability to support dynamic VRU zone creation in which the VRU zone tracks the location of a mobile UE. For example, the path of a motorcyclist or cyclist may be tracked by a VAE server to dynamically adjust the VRU zone to provide safety to the rider. The motorcyclist or cyclist UE may provide periodic location updates to the VAE server and the VAE server may update the VRU zone and alert vehicles that may be in proximity of the new VRU zone. An example scenario of dynamic VRU zone update is captured in FIG. 4. In this example, both UE1 and UE2 have been authorized for V2X services by the VAE server and a VASS manages the VRUP service. As a result, the VASS has subscribed to the VAE server to receive notifications on changes to V2P policy and/or VRU zone.

Step 1 of FIG. 4: An application client on UE1 makes a request for VRUP service for the user of UE1. The application client may comprise information, for example user activity, current and previously active applications, user consent for using user application context information, and other application context information that may be useful in V2P policy creation/update or V2P detection. In response, the VAE client on UE1 sends a request to a VAE server to create a V2P policy. UE1 may be a motorcyclist or cyclist requesting to create a temporary and dynamic VRU zone based on the route or path of travel of UE1. The VAE client may send information about the V2P policy as indicated in Table 2 of the Appendix and inform the VAE server that the request may be for the creation of a dynamic VRU zone that tracks the mobility of UE1 and to adjust the VRU zone accordingly. UE1 may also send the destination location in the request to the VAE server to provide information on potential routes UE1 may take and other information as previously specified in step 2 of FIG. 2.

Step 2: The VAE server sends a notification to the VASS to check if UE1 is authorized to create a V2P profile. The notification may comprise the information provided by the VAE client in step 1.

Step 3: The VASS returns a response to the VAE server with an authorization status allowing UE1 to create the V2P profile. The VASS may provide other information for use in the V2P policy as previously specified, such as an expiration time for the V2P policy, one or more notification alert conditions, and V2P communication parameters and provisioning.

Step 4: The VAE server may configure location management subscriptions for UE1 from entities that provides such services, such as an EES, a SEAL server, or the 5GS. Note that FIG. 4 does not show either the SEAL server or the EES.

Step 5: The VAE server may create a V2P policy with information received from the VAE client, the VASS, or local configuration. The V2P policy may comprise the information listed in Table 2 of the Appendix.

Step 6: The VAE server sends a status of the V2P policy request to the VAE client and may comprise information from the V2P policy that is pertinent to UE1, especially information that may be different from information UE1 may have provided previously. In creating the V2P policy, the VAE server may receive information from the VASS or local configuration that override information UE1 had provided when initiating the request to create the V2P policy. The VAE server may also provide an indication for the VAE client to provide application context information. At this time, the VAE server may activate V2P detection. The VAE client may send a response to the application client with a status of the VRUP request.

Step 7: As UE1 moves along a path to the destination location, the VAE client on UE1 may provide location updates to the VAE server. In addition, the VAE client may also send application context information received from applications to assist with V2P detection. Alternatively, the VAE server may also receive location updates from a SEAL server, an EES, or the 5GS.

Step 8: In response to the location update of UE1, the VAE server may adjust the VRU zone accordingly to align with UE1's new location. In the process of adjusting the VRU zone, the VAE server may detect that UE2 is entering the new VRU zone and needs to be notified of the presence of UE1. UE2 may be a vehicular UE and may have been outside the initial VRU zone when UE1 requested to create the V2P policy.

Step 9: VAE server may send a notification alert to UE2. The notification alert may either be an advance notice alert or a proximal alert depending on whether UE2 is within the outer or inner portions of the VRU zone. As part of the alert, VAE server may configure UE2 with V2P communication parameters to communicate with UE1 as previously described.

Systems and methods are proposed herein for pre-emptive vehicular to pedestrian detection. For example, the method described in FIG. 4 may comprise receiving, by a VAE client, a first request from an application client on a user equipment (UE) to enable vulnerable road user protection (VRUP) services associated with the UE. The method may further comprise sending a second request to a VAE server to create a vehicle to pedestrian (V2P) policy, wherein the V2P policy is configured to request creation of a vulnerable road user (VRU) zone associated with the UE. The method may further comprise receiving a first response to the second request indicating the status of the second request, the first response comprising information of the V2P policy that applies to the UE. The method may further comprise sending a second response to the first request indicating the status of the first request.

The method described in FIG. 4 may further comprise wherein at least one of the first response or the second response comprises one or more of a status of the request, a policy identifier, a policy expiration, V2P status, information about the VRU zone, an indicator whether the VRU zone is dynamic, a V2X profile indicator, notification alert settings, V2P communication parameters, a location reporting configuration, temporary constraints, application server identifiers, application context reporting, battery information, or opportunistic critical information delivery conditions.

The method described in FIG. 4 may further comprise wherein the second request comprises at least one of the UE identifier, the UE location, an indication for creating a V2P policy, location reporting configuration of the UE, conditions for which to send the UE alerts, V2P communication parameters, temporal constraints for V2P detection, or an indication of whether the VRU zone is dynamic.

The method described in FIG. 4 may further comprise wherein the V2P communication parameters comprise at least one of authorization and authentication information, radio communication parameters, access type parameters, V2X identifiers, V2X communication identifiers, a mode of communication, V2P communication mechanisms, a communication schedule, a network protocol, a device type, a V2X service identifier and message type, a transmission profile, and QoS parameters.

The method described in FIG. 4 may further comprise receiving a vehicle to pedestrian notification from a VAE server.

The method described in FIG. 4 may further comprise wherein the VAE client sends a notification to an application client on the UE in response to receiving a vehicle to pedestrian notification from a VAE server.

The method described in FIG. 4 may further comprise wherein the VAE client receives a VRUP notification from an application on the UE with application context information.

The method described in FIG. 4 may further comprise the VAE client sending the application context information to a VAE server.

The method described in FIG. 4 may further comprise wherein the application context information comprises one or more of an application identifier, an indication that an application type is active on the UE, an indication that the UE is within a threshold distance of a crosswalk, a route of navigation associated with the application, or an indication that an additional device associated with the UE is in use.

For example, the method described in FIG. 4 may comprise receiving, by a VAE server, a first request from a VAE client on a user equipment (UE) to create a vehicle to pedestrian (V2P) policy, wherein the V2P policy is configured to request creation of a vulnerable road user (VRU) zone associated with the UE. The method may further comprise sending a message to a Vertical Application Specific Server (VASS) to determine authorization of the first request to create the V2P policy. The method may further comprise receiving a response from the VASS, the response comprising at least one of authorization information, V2P policy expiration information, one or more notification alert conditions, or V2P communication parameters. The method may further comprise configuring at least one of a location management or a data analytics subscription for the UE. The method may further comprise creating the V2P policy to enable V2P detection. The method may further comprise sending a response to the first request comprising information associated with the V2P policy.

The method described in FIG. 4 may further comprise causing creation of a dynamic VRU zone associated with the UE.

The method described in FIG. 4 may further comprise wherein the UE is a first UE. The method may further comprise receiving at least one of a notification of UE mobility, a data analytics prediction, or application context information. The method may further comprise causing updating of the dynamic VRU zone associated with the first UE. The method may further comprise sending a notification to a second UE to at least one of alert of a potential collision or indicate V2P communication parameters for the second UE to communicate directly with the first UE.

The method described in FIG. 4 may further comprise wherein the first request comprises at least one of a UE identifier, a UE location, an indication for creating a V2P policy, a location reporting configuration of the UE, conditions for which to send the UE alerts, V2P communication parameters, temporal constraints for V2P detection, information associated with the creation of a VRU zone, or an indication of whether the VRU zone is dynamic.

The method described in FIG. 4 may further comprise wherein the V2P communication parameters comprise at least one of authorization and authentication information, radio communication parameters, access type parameters, V2X identifiers, V2X communication identifiers, a mode of communication, V2P communication mechanisms, a communication schedule, a network protocol, a device type, a V2X service identifier and message type, a transmission profile, and QoS parameters.

The method described in FIG. 4 may further comprise wherein the application context information comprises one or more of an application identifier, an indication that an application type is active on the first UE, an indication that the first UE is within a threshold distance of a crosswalk, a route of navigation associated with the application, or an indication that an additional device associated with the first UE is in use.

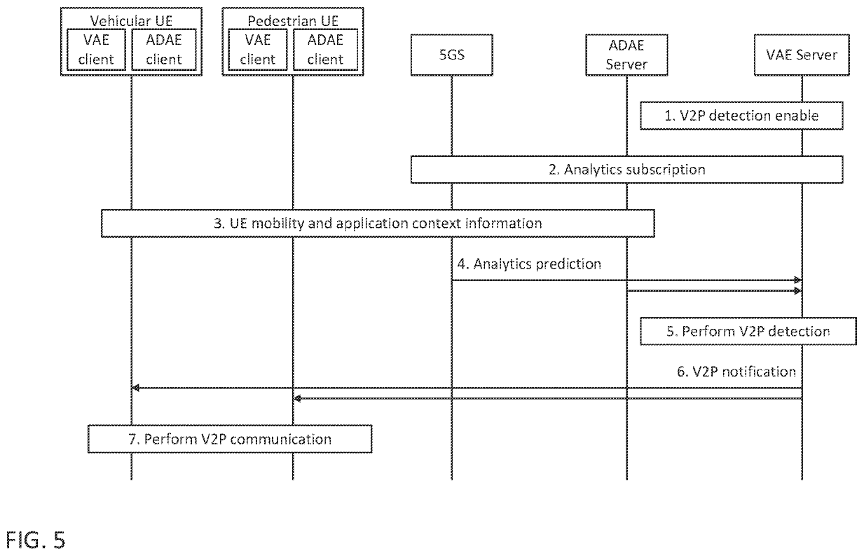

In addition to using UE mobility information or application context information, a VAE server may also utilize available data analytics that may offer predictions of UE mobility as part of V2P detection. FIG. 5 shows an example scenario where data analytic from either the 5GS or an Application Data Analytics Enabler (ADAE) server provides UE mobility prediction that a UE is moving towards a configured VRU zone. The analytics prediction may trigger a V2P detection and the resulting V2P notification where both the pedestrian and vehicular UEs are configured for V2P communication. Note that application context information may also be used by the analytics function to detect user attentiveness and identify the need to alert distracted users well in advance to provide the user with enough reaction time to avoid a potential collision.

Step 1 of FIG. 5: The V2P detection is enabled where the pedestrian UE is in a VRU zone as defined by a V2P policy on the VAE server. The V2P policy may comprise all the information found in Table 2 of the Appendix and may also comprise D2D communication parameters and provisioning information to enable V2P communication. At this time, the vehicular UE is outside the VRU zone.

Step 2: The VAE server makes a subscription to available data analytics functions either in an ADAE server or from the 5GS. The subscription is for data analytics on UE or application mobility outside of the VRU zone.

Step 3: The mobility information of the UEs is collected by the analytics functions within the 5GS and ADAE server. The VAE client may also provide application context information received from application clients to the ADAE server for generating analytics used for assisting V2P detection.

Step 4: The VAE server may receive analytics prediction from either or both the analytics function in the 5GS or the ADAE server about UE mobility and application context events. The analytics function may predict that the vehicular UE will be entering the VRU zone and at a high speed or the user is distracted and may be slow to react to an alert. As a result, the analytics function may notify the UEs sooner to provide enough time for the user to react to an alert.

Step 5: The VAE server may perform V2P detection using the analytics prediction and determine to notify both the vehicular and pedestrian UEs.

Step 6: The VAE server may send an advance notice alert to both the vehicular and pedestrian UEs with V2P configuration information for the UEs to communicate with each other.

Step 7: When the vehicular UE enters the VRU zone, the vehicular UE may establish communications with the pedestrian UE using the V2P configuration provided by the VAE server. The vehicular UE may also respond to the advance notice alert by slowing down the vehicle. Similarly, the VAE client may interrupt current UE activity to inform the user of the V2P alert.

### Graphical User Interface

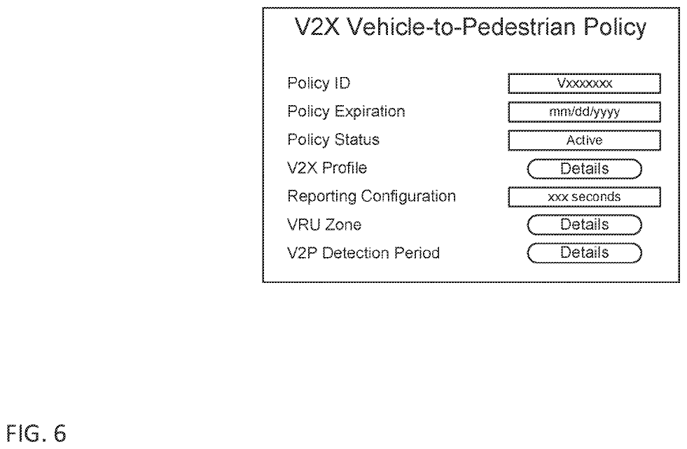

A graphical user interface such as the example shown in FIG. 6 may be used to display a portion of the V2P policy on the UE. The information presented in the GUI may be user centric and as a result, not all information listed in Table 2 of the Appendix may be shown to the user. For example, V2P communication parameters may not be of interest to the user and therefore, the V2P communication parameters may not be presented in the GUI. In addition, some of the presented information may not be user configured, such as the Policy ID, Policy Expiration, and Policy Status. The VAE server may provide this information to the VAE client on the UE.

In terms of user configurable information, a user may select a V2X Profile for the UE, e.g., a pedestrian, bicyclist, motorcyclist, vehicle, or the like. The location Reporting Configuration may also be configurable, but the configuration may be limited to operator or service provider controlled value. The VRU Zone may also be configured, especially for cases in which the user would like to create a temporary VRU zone. Within the VRU zone configuration, the user may define the VRU zone on a map and even select whether the VRU zone is dynamic to track the mobility of the UE. Finally, a user may select the times when V2P detection is enabled to be performed by the UE.

### Example Environments

The 3rd Generation Partnership Project (3GPP) develops technical standards for cellular telecommunications network technologies, including radio access, the core transport network, and service capabilities-including work on codecs, security, and quality of service. Recent radio access technology (RAT) standards comprise WCDMA (commonly referred as 3G), LTE (commonly referred as 4G), LTE-Advanced standards, and New Radio (NR), which is also referred to as “5G.” 3GPP NR standards development is expected to continue and comprise the definition of next generation radio access technology (new RAT), which is expected to comprise the provision of new flexible radio access below 7 GHz, and the provision of new ultra-mobile broadband radio access above 7 GHz. The flexible radio access is expected to consist of a new, non-backwards compatible radio access in new spectrum below 7 GHz, and it is expected to comprise different operating modes that may be multiplexed together in the same spectrum to address a broad set of 3GPP NR use cases with diverging requirements. The ultra-mobile broadband is expected to comprise cmWave and mmWave spectrum that will provide the opportunity for ultra-mobile broadband access for, e.g., indoor applications and hotspots. In particular, the ultra-mobile broadband is expected to share a common design framework with the flexible radio access below 7 GHz, with cmWave and mmWave specific design optimizations.

3GPP has identified a variety of use cases that NR is expected to support, resulting in a wide variety of user experience requirements for data rate, latency, and mobility. The use cases comprise the following general categories: enhanced mobile broadband (eMBB) ultra-reliable low-latency Communication (URLLC), massive machine type communications (mMTC), network operation (e.g., network slicing, routing, migration and interworking, energy savings), and enhanced vehicle-to-everything (eV2X) communications, which may comprise any of Vehicle-to-Vehicle Communication (V2V), Vehicle-to-Infrastructure Communication (V2I), Vehicle-to-Network Communication (V2N), Vehicle-to-Pedestrian Communication (V2P), and vehicle communications with other entities. Specific service and applications in these categories comprise, e.g., monitoring and sensor networks, device remote controlling, bi-directional remote controlling, personal cloud computing, video streaming, wireless cloud-based office, first responder connectivity, automotive recall, disaster alerts, real-time gaming, multi- person video calls, autonomous driving, augmented reality, tactile internet, virtual reality, home automation, robotics, and aerial drones to name a few. All of these use cases and others are contemplated herein.

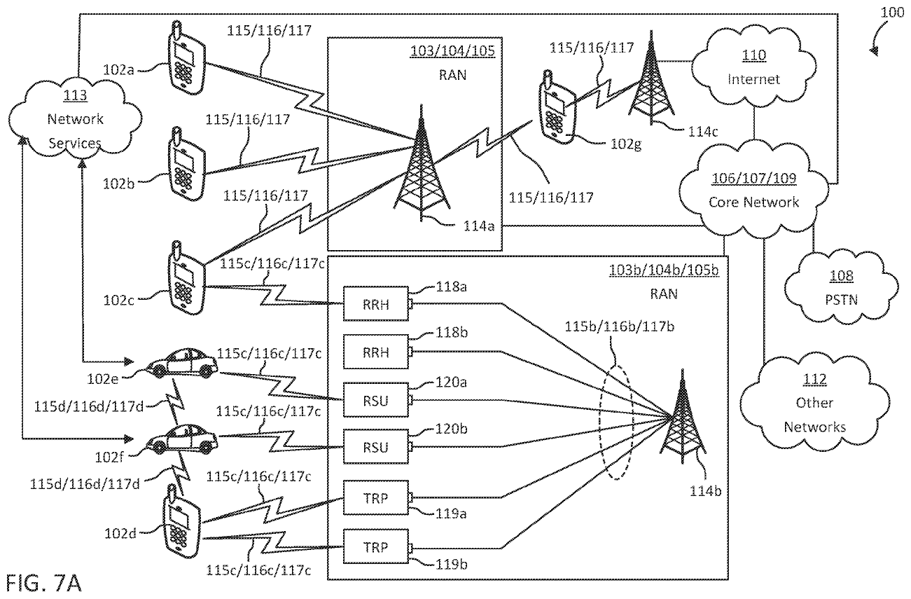

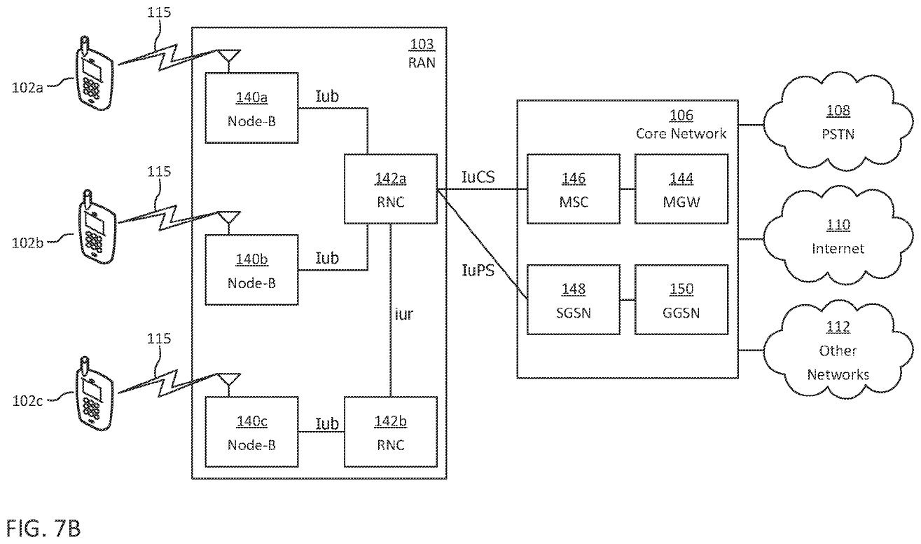

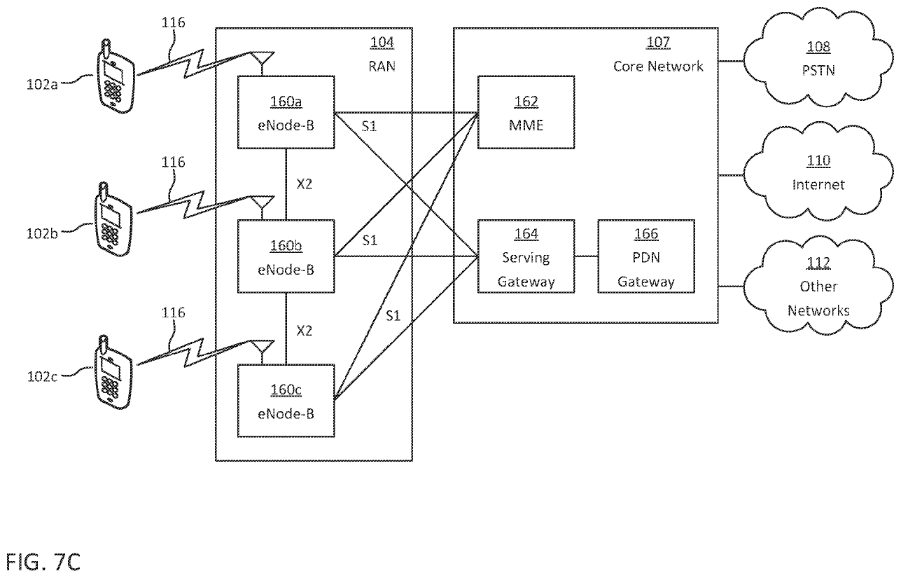

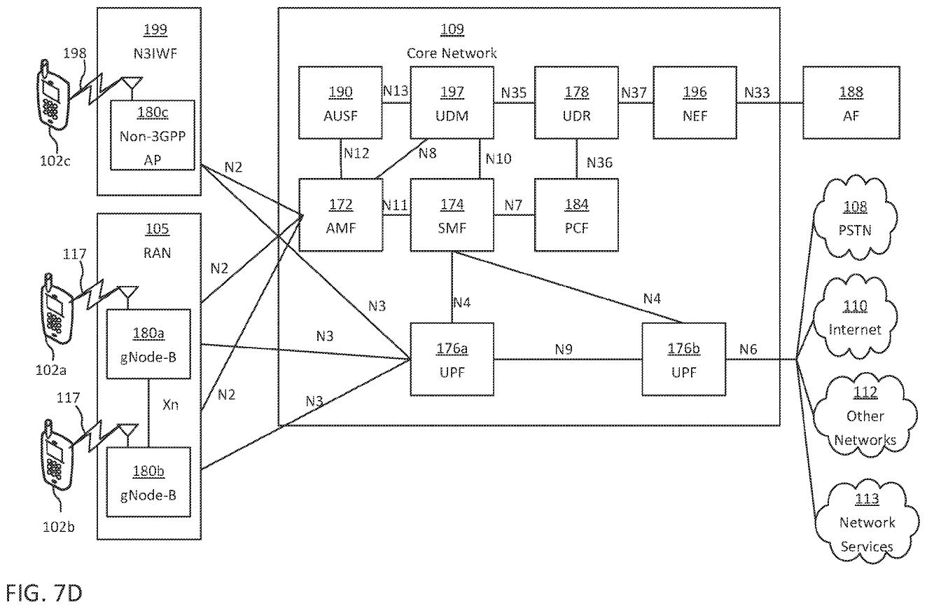

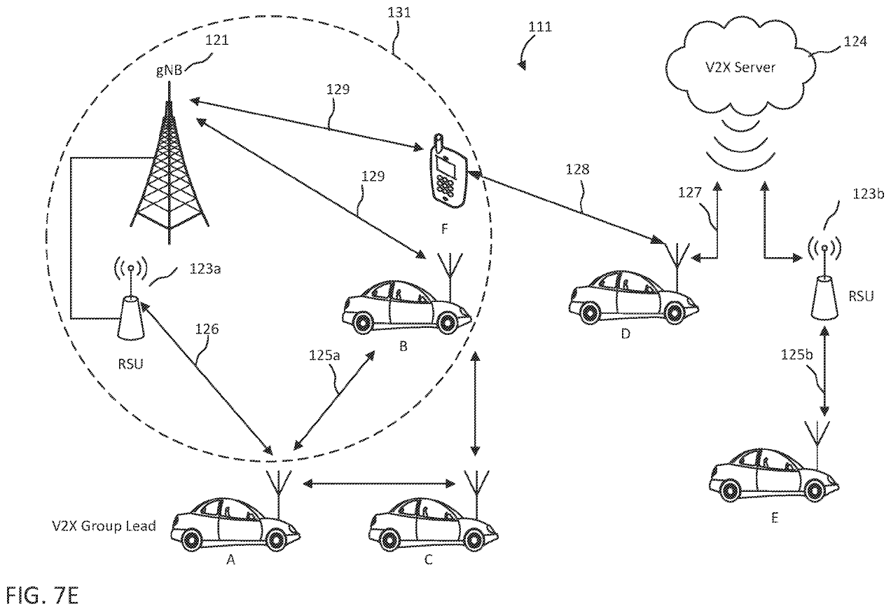

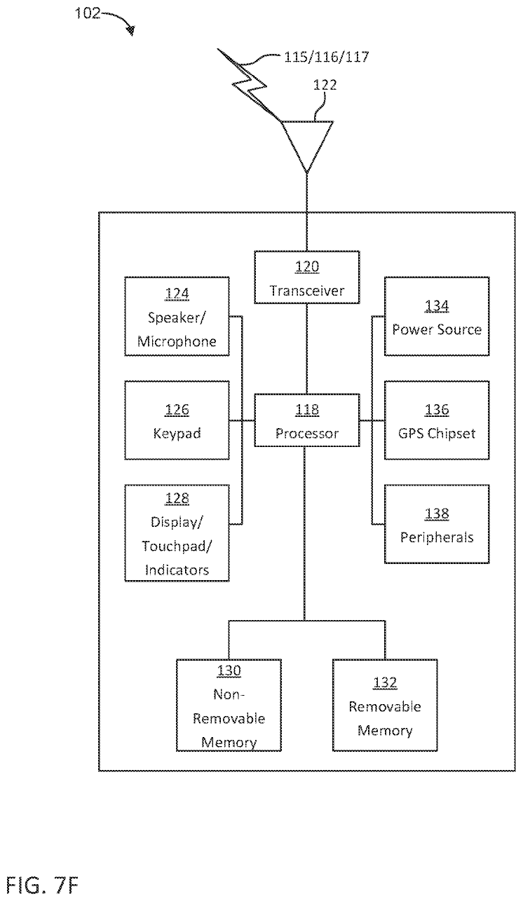

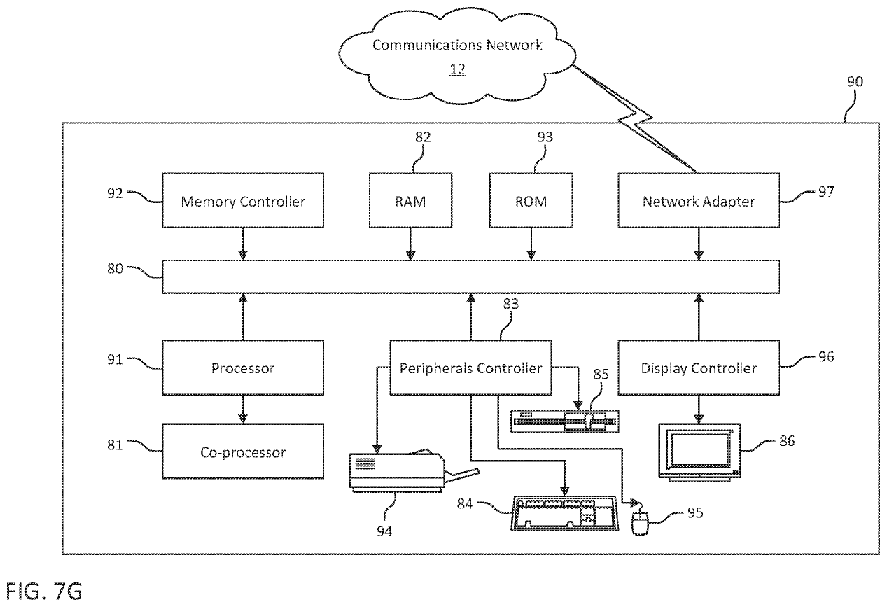

FIG. 7A shows an example communications system 100 in which the systems, methods, and apparatuses described and claimed herein may be used. The communications system 100 may comprise wireless transmit/receive units (WTRUs) 102a, 102b, 102c, 102d, 102e, 102f, and/or 102g, which generally or collectively may be referred to as WTRU 102 or WTRUs 102. The communications system 100 may comprise, a radio access network (RAN) 103/104/105/103b/104b/105b, a core network 106/107/109, a public switched telephone network (PSTN) 108, the Internet 110, other networks 112, and Network Services 113. 113. Network Services 113 may comprise, for example, a V2X server, V2X functions, a ProSe server, ProSe functions, IoT services, video streaming, and/or edge computing, or the like.

It will be appreciated that the concepts disclosed herein may be used with any quantity of WTRUs, base stations, networks, and/or network elements. Each of the WTRUs 102 may be any type of apparatus or device configured to operate and/or communicate in a wireless environment. In the example of FIG. 7A, each of the WTRUs 102 is depicted in FIGS. 7A-E as a hand-held wireless communications apparatus. It is understood that with the wide variety of use cases contemplated for wireless communications, each WTRU may comprise or be included in any type of apparatus or device configured to transmit and/or receive wireless signals, including, by way of example only, user equipment (UE), a mobile station, a fixed or mobile subscriber unit, a pager, a cellular telephone, a personal digital assistant (PDA), a smartphone, a laptop, a tablet, a netbook, a notebook computer, a personal computer, a wireless sensor, consumer electronics, a wearable device such as a smart watch or smart clothing, a medical or eHealth device, a robot, industrial equipment, a drone, a vehicle such as a car, bus or truck, a train, or an airplane, and the like.

The communications system 100 may also comprise a base station 114a and a base station 114b. In the example of FIG. 7A, each base stations 114a and 114b is depicted as a single element. In practice, the base stations 114a and 114b may comprise any quantity of interconnected base stations and/or network elements. Base stations 114a may be any type of device configured to wirelessly interface with at least one of the WTRUs 102a, 102b, and 102c to facilitate access to one or more communication networks, such as the core network 106/107/109, the Internet 110, Network Services 113, and/or the other networks 112. Similarly, base station 114b may be any type of device configured to wiredly and/or wirelessly interface with at least one of the Remote Radio Heads (RRHs) 118a, 118b, Transmission and Reception Points (TRPs) 119a, 119b, and/or Roadside Units (RSUs) 120a and 120b to facilitate access to one or more communication networks, such as the core network 106/107/109, the Internet 110, other networks 112, and/or Network Services 113. RRHs 118a, 118b may be any type of device configured to wirelessly interface with at least one of the WTRUs 102, e.g., WTRU 102c, to facilitate access to one or more communication networks, such as the core network 106/107/109, the Internet 110, Network Services 113, and/or other networks 112.

TRPs 119a, 119b may be any type of device configured to wirelessly interface with at least one of the WTRU 102d, to facilitate access to one or more communication networks, such as the core network 106/107/109, the Internet 110, Network Services 113, and/or other networks 112. RSUs 120a and 120b may be any type of device configured to wirelessly interface with at least one of the WTRU 102e or 102f, to facilitate access to one or more communication networks, such as the core network 106/107/109, the Internet 110, other networks 112, and/or Network Services 113. By way of example, the base stations 114a, 114b may be a Base Transceiver Station (BTS), a Node-B, an eNode B, a Home Node B, a Home eNode B, a Next Generation Node-B (gNode B), a satellite, a site controller, an access point (AP), a wireless router, and the like.

The base station 114a may be part of the RAN 103/104/105, which may also comprise other base stations and/or network elements (not shown), such as a Base Station Controller (BSC), a Radio Network Controller (RNC), relay nodes, or the like. Similarly, the base station 114b may be part of the RAN 103b/104b/105b, which may also comprise other base stations and/or network elements (not shown), such as a BSC, a RNC, relay nodes, or the like. The base station 114a may be configured to transmit and/or receive wireless signals within a particular geographic region, which may be referred to as a cell (not shown). Similarly, the base station 114b may be configured to transmit and/or receive wired and/or wireless signals within a particular geographic region, which may be referred to as a cell (not shown). The cell may further be divided into cell sectors. For example, the cell associated with the base station 114a may be divided into three sectors. Thus, for example, the base station 114a may comprise three transceivers, e.g., one for each sector of the cell. The base station 114a may employ Multiple-Input Multiple Output (MIMO) technology and, therefore, may utilize multiple transceivers for each sector of the cell, for example.

The base station 114a may communicate with one or more of the WTRUs 102a, 102b, 102c, and 102g over an air interface 115/116/117, which may be any suitable wireless communication link (e.g., Radio Frequency (RF), microwave, infrared (IR), ultraviolet (UV), visible light, cmWave, mmWave, or the like). The air interface 115/116/117 may be established using any suitable Radio Access Technology (RAT).

The base station 114b may communicate with one or more of the RRHs 118a and 118b, TRPs 119a and 119b, and/or RSUs 120a and 120b, over a wired or air interface 115b/116b/117b, which may be any suitable wired (e.g., cable, optical fiber, or the like) or wireless communication link (e.g., RF, microwave, IR, UV, visible light, cmWave, mmWave, or the like). The air interface 115b/116b/117b may be established using any suitable RAT.

The RRHs 118a, 118b, TRPs 119a, 119b and/or RSUs 120a, 120b, may communicate with one or more of the WTRUs 102c, 102d, 102e, 102f over an air interface 115c/116c/117c, which may be any suitable wireless communication link (e.g., RF, microwave, IR, ultraviolet UV, visible light, cmWave, mmWave, or the like) The air interface 115c/116c/117c may be established using any suitable RAT.

The WTRUs 102 may communicate with one another over a direct air interface 115d/116d/117d, such as Sidelink communication which may be any suitable wireless communication link (e.g., RF, microwave, IR, ultraviolet UV, visible light, cmWave, mmWave, or the like) The air interface 115d/116d/117d may be established using any suitable RAT.

The communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c, or RRHs 118a, 118b, TRPs 119a, 119b and/or RSUs 120a and 120b in the RAN 103b/104b/105b and the WTRUs 102c, 102d, 102e, and 102f, may implement a radio technology such as Universal Mobile Telecommunications System (UMTS) Terrestrial Radio Access (UTRA), which may establish the air interface 115/116/117 and/or 115c/116c/117c respectively using Wideband CDMA (WCDMA). WCDMA may comprise communication protocols such as High-Speed Packet Access (HSPA) and/or Evolved HSPA (HSPA+). HSPA may comprise High-Speed Downlink Packet Access (HSDPA) and/or High-Speed Uplink Packet Access (HSUPA).

The base station 114a in the RAN 103/104/105 and the WTRUs 102a, 102b, 102c, and 102g, or RRHs 118a and 118b, TRPs 119a and 119b, and/or RSUs 120a and 120b in the RAN 103b/104b/105b and the WTRUs 102c, 102d, may implement a radio technology such as Evolved UMTS Terrestrial Radio Access (E-UTRA), which may establish the air interface 115/116/117 or 115c/116c/117c respectively using Long Term Evolution (LTE) and/or LTE-Advanced (LTE-A), for example. The air interface 115/116/117 or 115c/116c/117c may implement 3GPP NR technology. The LTE and LTE-A technology may comprise LTE D2D and/or V2X technologies and interfaces (such as Sidelink communications, or the like) Similarly, the 3GPP NR technology may comprise NR V2X technologies and interfaces (such as Sidelink communications, or the like)

The base station 114a in the RAN 103/104/105 and the WTRUs 102a, 102b, 102c, and 102g or RRHs 118a and 118b, TRPs 119a and 119b, and/or RSUs 120a and 120b in the RAN 103b/104b/105b and the WTRUs 102c, 102d, 102e, and 102f may implement radio technologies such as IEEE 802.16 (e.g., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114c in FIG. 7A may be a wireless router, Home Node B, Home eNode B, or access point, for example, and may utilize any suitable RAT for facilitating wireless connectivity in a localized area, such as a place of business, a home, a vehicle, a train, an aerial, a satellite, a manufactory, a campus, and the like. The base station 114c and the WTRUs 102, e.g., WTRU 102e, may implement a radio technology such as IEEE 802.11 to establish a Wireless Local Area Network (WLAN). Similarly, the base station 114c and the WTRUs 102, e.g., WTRU 102d, may implement a radio technology such as IEEE 802.15 to establish a wireless personal area network (WPAN). The base station 114c and the WTRUs 102, e.g., WRTU 102e, may utilize a cellular-based RAT (e.g., WCDMA, CDMA2000, GSM, LTE, LTE-A, NR, or the like) to establish a picocell or femtocell. As shown in FIG. 7A, the base station 114c may have a direct connection to the Internet 110. Thus, the base station 114c may not be required to access the Internet 110 via the core network 106/107/109.

The RAN 103/104/105 and/or RAN 103b/104b/105b may be in communication with the core network 106/107/109, which may be any type of network configured to provide voice, data, messaging, authorization and authentication, applications, and/or Voice Over Internet Protocol (VOIP) services to one or more of the WTRUs 102. For example, the core network 106/107/109 may provide call control, billing services, mobile location-based services, pre-paid calling, Internet connectivity, packet data network connectivity, Ethernet connectivity, video distribution, or the like, and/or perform high-level security functions, such as user authentication.

Although not shown in FIG. 7A, it will be appreciated that the RAN 103/104/105 and/or RAN 103b/104b/105b and/or the core network 106/107/109 may be in direct or indirect communication with other RANs that employ the same RAT as the RAN 103/104/105 and/or RAN 103b/104b/105b or a different RAT. For example, in addition to being connected to the RAN 103/104/105 and/or RAN 103b/104b/105b, which may be utilizing an E-UTRA radio technology, the core network 106/107/109 may also be in communication with another RAN (not shown) employing a GSM or NR radio technology.

The core network 106/107/109 may also serve as a gateway for the WTRUs 102 to access the PSTN 108, the Internet 110, and/or other networks 112. The PSTN 108 may comprise circuit-switched telephone networks that provide Plain Old Telephone Service (POTS). The Internet 110 may comprise a global system of interconnected computer networks and devices that use common communication protocols, such as the Transmission Control Protocol (TCP), User Datagram Protocol (UDP), and the internet protocol (IP) in the TCP/IP internet protocol suite. The other networks 112 may comprise wired or wireless communications networks owned and/or operated by other service providers. For example, the networks 112 may comprise any type of packet data network (e.g., an IEEE 802.3 Ethernet network) or another core network connected to one or more RANs, which may employ the same RAT as the RAN 103/104/105 and/or RAN 103b/104b/105b or a different RAT.

Some or all of the WTRUs 102a, 102b, 102c, 102d, 102e, and 102f in the communications system 100 may comprise multi-mode capabilities, e.g., the WTRUs 102a, 102b, 102c, 102d, 102e, and 102f may comprise multiple transceivers for communicating with different wireless networks over different wireless links. For example, the WTRU 102g shown in FIG. 7A may be configured to communicate with the base station 114a, which may employ a cellular-based radio technology, and with the base station 114c, which may employ an IEEE 802 radio technology.

Although not shown in FIG. 7A, it will be appreciated that a User Equipment may make a wired connection to a gateway. The gateway maybe a Residential Gateway (RG). The RG may provide connectivity to a Core Network 106/107/109. It will be appreciated that many of the ideas contained herein may equally apply to UEs that are WTRUs and UEs that use a wired connection to connect to a network. For example, the ideas that apply to the wireless interfaces 115, 116, 117 and 115c/116c/117c may equally apply to a wired connection.

FIG. 7B is a system diagram of an example RAN 103 and core network 106. As noted above, the RAN 103 may employ a UTRA radio technology to communicate with the WTRUs 102a, 102b, and 102c over the air interface 115. The RAN 103 may also be in communication with the core network 106. As shown in FIG. 7B, the RAN 103 may comprise Node-Bs 140a, 140b, and 140c, which may each comprise one or more transceivers for communicating with the WTRUs 102a, 102b, and 102c over the air interface 115. The Node-Bs 140a, 140b, and 140c may each be associated with a particular cell (not shown) within the RAN 103. The RAN 103 may also comprise RNCs 142a, 142b. It will be appreciated that the RAN 103 may comprise any quantity of Node-Bs and Radio Network Controllers (RNCs.)

As shown in FIG. 7B, the Node-Bs 140a, 140b may be in communication with the RNC 142a. Additionally, the Node-B 140c may be in communication with the RNC 142b. The Node-Bs 140a, 140b, and 140c may communicate with the respective RNCs 142a and 142b via an Iub interface. The RNCs 142a and 142b may be in communication with one another via an Iur interface. Each of the RNCs 142a and 142b may be configured to control the respective Node-Bs 140a, 140b, and 140c to which it is connected. In addition, each of the RNCs 142a and 142b may be configured to carry out or support other functionality, such as outer loop power control, load control, admission control, packet scheduling, handover control, macro-diversity, security functions, data encryption, and the like.

The core network 106 shown in FIG. 7B may comprise a media gateway (MGW) 144, a Mobile Switching Center (MSC) 146, a Serving GPRS Support Node (SGSN) 148, and/or a Gateway GPRS Support Node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, and 102c with access to circuit-switched networks, such as the PSTN 108, to facilitate communications between the WTRUs 102a, 102b, and 102c, and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, and 102c with access to packet-switched networks, such as the Internet 110, to facilitate communications between and the WTRUs 102a, 102b, and 102c, and IP-enabled devices.

The core network 106 may also be connected to the other networks 112, which may comprise other wired or wireless networks that are owned and/or operated by other service providers.

FIG. 7C is a system diagram of an example RAN 104 and core network 107. As noted above, the RAN 104 may employ an E-UTRA radio technology to communicate with the WTRUs 102a, 102b, and 102c over the air interface 116. The RAN 104 may also be in communication with the core network 107.

The RAN 104 may comprise eNode-Bs 160a, 160b, and 160c, though it will be appreciated that the RAN 104 may comprise any quantity of eNode-Bs. The eNode-Bs 160a, 160b, and 160c may each comprise one or more transceivers for communicating with the WTRUs 102a, 102b, and 102c over the air interface 116. For example, the eNode-Bs 160a, 160b, and 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink and/or downlink, and the like. As shown in FIG. 7C, the eNode-Bs 160a, 160b, and 160c may communicate with one another over an X2 interface.

The core network 107 shown in FIG. 7C may comprise a Mobility Management Gateway (MME) 162, a serving gateway 164, and a Packet Data Network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, and 160c in the RAN 104 via an SI interface and may serve as a control node. For example, the MME 162 may be responsible for authenticating users of the WTRUs 102a, 102b, and 102c, bearer activation/deactivation, selecting a particular serving gateway during an initial attach of the WTRUs 102a, 102b, and 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, and 160c in the RAN 104 via the SI interface. The serving gateway 164 may generally route and forward user data packets to/from the WTRUs 102a, 102b, and 102c. The serving gateway 164 may also perform other functions, such as anchoring user planes during inter-eNode B handovers, triggering paging when downlink data is available for the WTRUs 102a, 102b, and 102c, managing and storing contexts of the WTRUs 102a, 102b, and 102c, and the like.

The serving gateway 164 may also be connected to the PDN gateway 166, which may provide the WTRUs 102a, 102b, and 102c with access to packet-switched networks, such as the Internet 110, to facilitate communications between the WTRUs 102a, 102b, 102c, and IP-enabled devices.

The core network 107 may facilitate communications with other networks. For example, the core network 107 may provide the WTRUs 102a, 102b, and 102c with access to circuit-switched networks, such as the PSTN 108, to facilitate communications between the WTRUs 102a, 102b, and 102c and traditional land-line communications devices. For example, the core network 107 may comprise, or may communicate with, an IP gateway (e.g., an IP Multimedia Subsystem (IMS) server) that serves as an interface between the core network 107 and the PSTN 108. In addition, the core network 107 may provide the WTRUs 102a, 102b, and 102c with access to the networks 112, which may comprise other wired or wireless networks that are owned and/or operated by other service providers.

FIG. 7D is a system diagram of an example RAN 105 and core network 109. The RAN 105 may employ an NR radio technology to communicate with the WTRUs 102a and 102b over the air interface 117. The RAN 105 may also be in communication with the core network 109. A Non-3GPP Interworking Function (N3IWF) 199 may employ a non-3GPP radio technology to communicate with the WTRU 102c over the air interface 198. The N3IWF 199 may also be in communication with the core network 109.

The RAN 105 may comprise gNode-Bs 180a and 180b. It will be appreciated that the RAN 105 may comprise any quantity of gNode-Bs. The gNode-Bs 180a and 180b may each comprise one or more transceivers for communicating with the WTRUs 102a and 102b over the air interface 117. When integrated access and backhaul connection are used, the same air interface may be used between the WTRUs and gNode-Bs, which may be the core network 109 via one or multiple gNBs. The gNode-Bs 180a and 180b may implement MIMO, MU-MIMO, and/or digital beamforming technology. Thus, the gNode-B 180a, for example, may use multiple antennas to transmit wireless signals to, and receive wireless signals from, the WTRU 102a. It should be appreciated that the RAN 105 may employ of other types of base stations such as an eNode-B. It will also be appreciated the RAN 105 may employ more than one type of base station. For example, the RAN may employ eNode-Bs and gNode-Bs.

The N3IWF 199 may comprise a non-3GPP Access Point 180c. It will be appreciated that the N3IWF 199 may comprise any quantity of non-3GPP Access Points. The non-3GPP Access Point 180c may comprise one or more transceivers for communicating with the WTRUs 102c over the air interface 198. The non-3GPP Access Point 180c may use the 802.11 protocol to communicate with the WTRU 102c over the air interface 198.

Each of the gNode-Bs 180a and 180b may be associated with a particular cell (not shown) and may be configured to handle radio resource management decisions, handover decisions, scheduling of users in the uplink and/or downlink, and the like. As shown in FIG. 7D, the gNode-Bs 180a and 180b may communicate with one another over an Xn interface, for example.

The core network 109 shown in FIG. 7D may be a 5G core network (5GC). The core network 109 may offer numerous communication services to customers who are interconnected by the radio access network. The core network 109 comprises a quantity of entities that perform the functionality of the core network. As used herein, the term “core network entity” or “network function” refers to any entity that performs one or more functionalities of a core network. It is understood that such core network entities may be logical entities that are implemented in the form of computer-executable instructions (software) stored in a memory of, and executing on a processor of, an apparatus configured for wireless and/or network communications or a computer system, such as system 90 illustrated in FIG. 7G.

In the example of FIG. 7D, the 5G Core Network 109 may comprise an access and mobility management function (AMF) 172, a Session Management Function (SMF) 174, User Plane Functions (UPFs) 176a and 176b, a User Data Management Function (UDM) 197, an Authentication Server Function (AUSF) 190, a Network Exposure Function (NEF) 196, a Policy Control Function (PCF) 184, a Non-3GPP Interworking Function (N3IWF) 199, a User Data Repository (UDR) 178. While each of the foregoing elements are depicted as part of the 5G core network 109, it will be appreciated that any one of these elements may be owned and/or operated by an entity other than the core network operator. It will also be appreciated that a 5G core network may not consist of all of these elements, may consist of additional elements, and may comprise multiple examples of each of these elements. FIG. 7D shows that network functions directly connect to one another, however, it should be appreciated that they may communicate via routing agents such as a diameter routing agent or message buses.

In the example of FIG. 7D, connectivity between network functions is achieved via a set of interfaces, or reference points. It will be appreciated that network functions could be modeled, described, or implemented as a set of services that are invoked, or called, by other network functions or services. Invocation of a Network Function service may be achieved via a direct connection between network functions, an exchange of messaging on a message bus, calling a software function, or the like.

The AMF 172 may be connected to the RAN 105 via an N2 interface and may serve as a control node. For example, the AMF 172 may be responsible for registration management, connection management, reachability management, access authentication, access authorization. The AMF may be responsible forwarding user plane tunnel configuration information to the RAN 105 via the N2 interface. The AMF 172 may receive the user plane tunnel configuration information from the SMF via an N11 interface. The AMF 172 may generally route and forward NAS packets to/from the WTRUs 102a, 102b, and 102c via an N1 interface. The N1 interface is not shown in FIG. 7D.

The SMF 174 may be connected to the AMF 172 via an N11 interface. Similarly, the SMF may be connected to the PCF 184 via an N7 interface, and to the UPFs 176a and 176b via an N4 interface. The SMF 174 may serve as a control node. For example, the SMF 174 may be responsible for Session Management, IP address allocation for the WTRUs 102a, 102b, and 102c, management and configuration of traffic steering rules in the UPF 176a and UPF 176b, and generation of downlink data notifications to the AMF 172.

The UPF 176a and UPF 176b may provide the WTRUs 102a, 102b, and 102c with access to a Packet Data Network (PDN), such as the Internet 110, to facilitate communications between the WTRUs 102a, 102b, and 102c and other devices. The UPF 176a and UPF 176b may also provide the WTRUs 102a, 102b, and 102c with access to other types of packet data networks. For example, Other Networks 112 may be Ethernet Networks or any type of network that exchanges packets of data. The UPF 176a and UPF 176b may receive traffic steering rules from the SMF 174 via the N4 interface. The UPF 176a and UPF 176b may provide access to a packet data network by connecting a packet data network with an N6 interface or by connecting to each other and to other UPFs via an N9 interface. In addition to providing access to packet data networks, the UPF 176 may be responsible packet routing and forwarding, policy rule enforcement, quality of service handling for user plane traffic, downlink packet buffering.

The AMF 172 may also be connected to the N3IWF 199, for example, via an N2 interface. The N3IWF facilitates a connection between the WTRU 102c and the 5G core network 170, for example, via radio interface technologies that are not defined by 3GPP. The AMF may interact with the N3IWF 199 in the same, or similar, manner that it interacts with the RAN 105.

The PCF 184 may be connected to the SMF 174 via an N7 interface, connected to the AMF 172 via an N15 interface, and to an Application Function (AF) 188 via an N5 interface. The N15 and N5 interfaces are not shown in FIG. 7D. The PCF 184 may provide policy rules to control plane nodes such as the AMF 172 and SMF 174, allowing the control plane nodes to enforce these rules. The PCF 184 may send policies to the AMF 172 for the WTRUs 102a, 102b, and 102c so that the AMF may deliver the policies to the WTRUs 102a, 102b, and 102c via an N1 interface. Policies may be enforced, or applied, at the WTRUs 102a, 102b, and 102c.

The UDR 178 may act as a repository for authentication credentials and subscription information. The UDR may connect to network functions, so that network function may add to, read from, and modify the data that is in the repository. For example, the UDR 178 may connect to the PCF 184 via an N36 interface. Similarly, the UDR 178 may connect to the NEF 196 via an N37 interface, and the UDR 178 may connect to the UDM 197 via an N35 interface.

The UDM 197 may serve as an interface between the UDR 178 and other network functions. The UDM 197 may authorize network functions to access of the UDR 178. For example, the UDM 197 may connect to the AMF 172 via an N8 interface, the UDM 197 may connect to the SMF 174 via an N10 interface. Similarly, the UDM 197 may connect to the AUSF 190 via an N13 interface. The UDR 178 and UDM 197 may be tightly integrated.

The AUSF 190 performs authentication related operations and connects to the UDM 178 via an N13 interface and to the AMF 172 via an N12 interface.

The NEF 196 exposes capabilities and services in the 5G core network 109 to Application Functions (AF) 188. Exposure may occur on the N33 API interface. The NEF may connect to an AF 188 via an N33 interface, and it may connect to other network functions in order to expose the capabilities and services of the 5G core network 109.

Application Functions 188 may interact with network functions in the 5G Core Network 109. Interaction between the Application Functions 188 and network functions may be via a direct interface or may occur via the NEF 196. The Application Functions 188 may be considered part of the 5G Core Network 109 or may be external to the 5G Core Network 109 and deployed by enterprises that have a business relationship with the mobile network operator.

Network Slicing is a mechanism that could be used by mobile network operators to support one or more ‘virtual’ core networks behind the operator's air interface. This involves ‘slicing’ the core network into one or more virtual networks to support different RANs or different service types running across a single RAN. Network slicing enables the operator to create networks customized to provide optimized solutions for different market scenarios which demands diverse requirements, e.g., in the areas of functionality, performance, and isolation.

3GPP has designed the 5G core network to support Network Slicing. Network Slicing is a useful tool that network operators may use to support the diverse set of 5G use cases (e.g., massive IoT, critical communications, V2X, and enhanced mobile broadband) which demand diverse and sometimes extreme requirements. Without the use of network slicing techniques, it is likely that the network architecture would not be flexible and scalable enough to efficiently support a wider range of use cases need when each use case has its own specific set of performance, scalability, and availability requirements. Furthermore, introduction of new network services should be made more efficient.

Referring again to FIG. 7D, in a network slicing scenario, a WTRU 102a, 102b, or 102c may connect to an AMF 172, via an N1 interface. The AMF may be logically part of one or more slices. The AMF may coordinate the connection or communication of WTRU 102a, 102b, or 102c with one or more UPF 176a and 176b, SMF 174, and other network functions. Each of the UPFs 176a and 176b, SMF 174, and other network functions may be part of the same slice or different slices. When they are part of different slices, they may be isolated from each other in the sense that they may utilize different computing resources, security credentials, or the like.

The core network 109 may facilitate communications with other networks. For example, the core network 109 may comprise, or may communicate with, an IP gateway, such as an IP Multimedia Subsystem (IMS) server, which serves as an interface between the 5G core network 109 and a PSTN 108. For example, the core network 109 may comprise, or communicate with a short message service (SMS) service center that facilities communication via the short message service. For example, the 5G core network 109 may facilitate the exchange of non-IP data packets between the WTRUs 102a, 102b, and 102c and servers or applications functions 188. In addition, the core network 170 may provide the WTRUs 102a, 102b, and 102c with access to the networks 112, which may comprise other wired or wireless networks that are owned and/or operated by other service providers.

The core network entities described herein and illustrated in FIG. 7A, FIG. 7C, FIG. 7D, and FIG. 7E are identified by the names given to those entities in certain existing 3GPP specifications, but it is understood that in the future those entities and functionalities may be identified by other names, and certain entities or functions may be combined in future specifications published by 3GPP, including future 3GPP NR specifications. Thus, the particular network entities and functionalities described and illustrated in FIGS. 7A-E are provided by way of example only, and it is understood that the subject matter disclosed and claimed herein may be embodied or implemented in any similar communication system, whether presently defined or defined in the future.

FIG. 7E shows an example communications system 111 in which the systems, methods, apparatuses described herein may be used. Communications system 111 may comprise Wireless Transmit/Receive Units (WTRUs) A, B, C, D, E, F, a base station gNB 121, a V2X server 124, and Roadside Units (RSUs) 123a and 123b. In practice, the concepts presented herein may be applied to any quantity of WTRUs, base station gNBs, V2X networks, and/or other network elements. One or several or all WTRUs A, B, C, D, E, and F may be out of range of the access network coverage 131. WTRUs A, B, and C form a V2X group, among which WTRU A is the group lead and WTRUs B and Care group members.

WTRUs A, B, C, D, E, and F may communicate with each other over a Uu interface 129 via the gNB 121 if they are within the access network coverage 131. In the example of FIG. 7E, WTRUs B and F are shown within access network coverage 131. WTRUs A, B, C, D, E, and F may communicate with each other directly via a Sidelink interface (e.g., PC5 or NR PC5) such as interface 125a, 125b, or 128, whether they are under the access network coverage 131 or out of the access network coverage 131. For example, in the example of FIG. 7E, WRTUD, which is outside of the access network coverage 131, communicates with WTRU F, which is inside the coverage 131.

WTRUs A, B, C, D, E, and F may communicate with RSU 123a or 123b via a Vehicle-to-Network (V2N) 133 or Sidelink interface 125b. WTRUs A, B, C, D, E, and F may communicate to a V2X Server 124 via a Vehicle-to-Infrastructure (V2I) interface 127. WTRUs A, B, C, D, E, and F may communicate to another UE via a Vehicle-to-Person (V2P) interface 128.

FIG. 7F is a block diagram of an example apparatus or device WTRU 102 that may be configured for wireless communications and operations in accordance with the systems, methods, and apparatuses described herein, such as a WTRU 102 of FIGS. 7A-E. As shown in FIG. 7F, the example WTRU 102 may comprise a processor 118, a transceiver 120, a transmit/receive element 122, a speaker/microphone 124, a keypad 126, a display/touchpad/indicators 128, non-removable memory 130, removable memory 132, a power source 134, a global positioning system (GPS) chipset 136, and other peripherals 138. It will be appreciated that the WTRU 102 may comprise any sub-combination of the foregoing elements. Also, the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, a next generation node-B (gNode-B), and proxy nodes, among others, may comprise some or all of the elements depicted in FIG. 7F and described herein.

The processor 118 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 7F depicts the processor 118 and the transceiver 120 as separate components, it will be appreciated that the processor 118 and the transceiver 120 may be integrated together in an electronic package or chip.

The transmit/receive element 122 of a UE may be configured to transmit signals to, or receive signals from, a base station (e.g., the base station 114a of FIG. 7A) over the air interface 115/116/117 or another UE over the air interface 115d/116d/117d. For example, the transmit/receive element 122 may be an antenna configured to transmit and/or receive RF signals. The transmit/receive element 122 may be an emitter/detector configured to transmit and/or receive IR, UV, or visible light signals, for example. The transmit/receive element 122 may be configured to transmit and receive both RF and light signals. It will be appreciated that the transmit/receive element 122 may be configured to transmit and/or receive any combination of wireless or wired signals.

In addition, although the transmit/receive element 122 is depicted in FIG. 7F as a single element, the WTRU 102 may comprise any quantity of transmit/receive elements 122. More specifically, the WTRU 102 may employ MIMO technology. Thus, the WTRU 102 may comprise two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may comprise multiple transceivers for enabling the WTRU 102 to communicate via multiple RATs, for example NR and IEEE 802.11 or NR and E-UTRA, or to communicate with the same RAT via multiple beams to different RRHs, TRPs, RSUs, or nodes.

The processor 118 of the WTRU 102 may be coupled to, and may receive user input data from, the speaker/microphone 124, the keypad 126, and/or the display/touchpad/indicators 128 (e.g., a liquid crystal display (LCD) display unit or organic light-emitting diode (OLED) display unit. The processor 118 may also output user data to the speaker/microphone 124, the keypad 126, and/or the display/touchpad/indicators 128. In addition, the processor 118 may access information from, and store data in, any type of suitable memory, such as the non-removable memory 130 and/or the removable memory 132. The non-removable memory 130 may comprise random-access memory (RAM), read-only memory (ROM), a hard disk, or any other type of memory storage device. The removable memory 132 may comprise a subscriber identity module (SIM) card, a memory stick, a secure digital (SD) memory card, and the like. The processor 118 may access information from, and store data in, memory that is not physically located on the WTRU 102, such as on a server that is hosted in the cloud or in an edge computing platform or in a home computer (not shown).

The processor 118 may receive power from the power source 134 and may be configured to distribute and/or control the power to the other components in the WTRU 102. The power source 134 may be any suitable device for powering the WTRU 102. For example, the power source 134 may comprise one or more dry cell batteries, solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method.

The processor 118 may further be coupled to other peripherals 138, which may comprise one or more software and/or hardware modules that provide additional features, functionality, and/or wired or wireless connectivity. For example, the peripherals 138 may comprise various sensors such as an accelerometer, biometrics (e.g., finger print) sensors, an e-compass, a satellite transceiver, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The WTRU 102 may be included in other apparatuses or devices, such as a sensor, consumer electronics, a wearable device such as a smart watch or smart clothing, a medical or eHealth device, a robot, industrial equipment, a drone, a vehicle such as a car, truck, train, or an airplane. The WTRU 102 may connect to other components, modules, or systems of such apparatuses or devices via one or more interconnect interfaces, such as an interconnect interface that may comprise one of the peripherals 138.

FIG. 7G is a block diagram of an exemplary computing system 90 in which one or more apparatuses of the communications networks illustrated in FIG. 7A, FIG. 7C, FIG. 7D and FIG. 7E may be embodied, such as certain nodes or functional entities in the RAN 103/104/105, Core Network 106/107/109, PSTN 108, Internet 110, Other Networks 112, or Network Services 113. Computing system 90 may comprise a computer or server and may be controlled primarily by computer readable instructions, which may be in the form of software, wherever, or by whatever means such software is stored or accessed. Such computer readable instructions may be executed within a processor 91, to cause computing system 90 to do work. The processor 91 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 91 may perform signal coding, data processing, power control, input/output processing, and/or any other functionality that enables the computing system 90 to operate in a communications network. Coprocessor 81 is an optional processor, distinct from main processor 91, that may perform additional functions or assist processor 91. Processor 91 and/or coprocessor 81 may receive, generate, and process data related to the methods and apparatuses disclosed herein.

In operation, processor 91 fetches, decodes, and executes instructions, and transfers information to and from other resources via the computing system's main data-transfer path, system bus 80. Such a system bus connects the components in computing system 90 and defines the medium for data exchange. System bus 80 typically comprises data lines for sending data, address lines for sending addresses, and control lines for sending interrupts and for operating the system bus. An example of such a system bus 80 is the PCI (Peripheral Component Interconnect) bus.

Memories coupled to system bus 80 comprise random access memory (RAM) 82 and read only memory (ROM) 93. Such memories comprise circuitry that allows information to be stored and retrieved. ROMs 93 generally comprise stored data that may not easily be modified. Data stored in RAM 82 may be read or changed by processor 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it may not access memory within another process's virtual address space unless memory sharing between the processes has been set up.

In addition, computing system 90 may comprise peripherals controller 83 responsible for communicating instructions from processor 91 to peripherals, such as printer 94, keyboard 84, mouse 95, and disk drive 85.

Display 86, which is controlled by display controller 96, is used to display visual output generated by computing system 90. Such visual output may comprise text, graphics, animated graphics, and video. The visual output may be provided in the form of a graphical user interface (GUI). Display 86 may be implemented with a CRT-based video display, an LCD-based flat-panel display, gas plasma-based flat-panel display, or a touch-panel. Display controller 96 comprises electronic components required to generate a video signal that is sent to display 86.

Further, computing system 90 may comprise communication circuitry, such as for example a wireless or wired network adapter 97, that may be used to connect computing system 90 to an external communications network or devices, such as the RAN 103/104/105, Core Network 106/107/109, PSTN 108, Internet 110, WTRUs 102, or Other Networks 112 of FIGS. 7A-1E, to enable the computing system 90 to communicate with other nodes or functional entities of those networks. The communication circuitry, alone or in combination with the processor 91, may be used to perform the transmitting and receiving steps of certain apparatuses, nodes, or functional entities described herein.

It is understood that any or all of the apparatuses, systems, methods, and processes described herein may be embodied in the form of computer executable instructions (e.g., program code) stored on a computer-readable storage medium which instructions, when executed by a processor, such as processors 118 or 91, cause the processor to perform and/or implement the systems, methods and processes described herein. Specifically, any of the steps, operations, or functions described herein may be implemented in the form of such computer executable instructions, executing on the processor of an apparatus or computing system configured for wireless and/or wired network communications. Computer readable storage media comprises volatile and nonvolatile, removable, and non-removable media implemented in any non-transitory (e.g., tangible, or physical) method or technology for storage of information, but such computer readable storage media do not comprise signals. Computer readable storage media comprise, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which may be used to store the desired information, and which may be accessed by a computing system.

### APPENDIX

TABLE 1
Selected Acronyms

| | |
|---|---|
| 3GPP | Third Generation Partnership Project |
| 5GS | 5G System |
| AC | Application Client |
| ACR | Application Context Relocation |
| AF | Application Function |
| API | Application Programming Interface |
| AS | Application Server |
| D2D | Device-to-device |
| EAS | Edge Application Server |
| EEC | Edge Enabler Client |
| EEL | Edge Enabler Layer |
| EES | Edge Enabler Server |
| FQDN | Fully Qualified Domain Name |
| GPS | Global Positioning System |
| GUI | Graphical User Interface |
| NEF | Network Exposure Function |
| OAM | Operations, Administration, and Management |
| QoS | Quality of Service |
| RAN | Radio Access Network |
| SEAL | Service Enabler Architecture Layer for Verticals |
| TOD | Tele-operated Driving |
| UE | User Equipment |
| V2P | Vehicle to Pedestrian |
| V2X | Vehicle-to-Everything |
| VAE | V2X Application Enabler |
| VAL | Vertical Application Layer |
| VASS | V2X Application Specific Server |
| VRU | Vulnerable Road User |
| VRUP | Vulnerable Road User Protection |

TABLE 2
V2P Policy Example

| Parameter | Description |
|---|---|
| Policy identifier | An identifier for the V2P policy |
| Policy expiration | A time that the V2P policy expires |
| V2P status | A status indicator of whether the policy is in effect for V2P detection |
| UE identifiers | A list of UE or group identifiers for which the V2P policy applies to; notification alerts |
| | may be sent to the identified UEs upon the determination of a potential collision. The |
| | identifiers may also be used for enabling proximal V2P detection of the affected |
| | vehicular and pedestrian UEs. |
| VRU zones | List of VRU zones that is applicable to the V2P policy; the VRU zones may be divided |
| | in an outer zone for advanced V2P detection and an inner zone for proximal V2P |
| | detection. The VRU zone may be indicated with a provisioned identifier to refer to the |
| | coverage area. |
| Dynamic zone | An indicator showing whether a VRU zone is dynamic to track a mobile UE, such as |
| | that of an ice cream truck of a cyclist. |
| V2X profile | An indicator of the characteristic of the V2X UE such as a pedestrian, a bicyclist, a |
| indicator | motorcyclist, or a vehicle. The indicator may assist with determining the speed of a UE |
| | mobility event and the vulnerability of the user. |
| Notification alert | A list of conditions and the corresponding notification/alert message that may be sent |
| settings | |
| V2P communication | Parameters for V2P communication that may comprise authorization and |
| parameters | authentication information, radio communication parameters, parameters for the |
| | selected access type (e.g. network or direct communication), V2X identifiers, |
| | identifiers for the appropriate V2X communication (e.g. destination Layer2-ID), |
| | information for mode of communication, V2P communication mechanisms (e.g., |
| | unicast, groupcast, multicast, or broadcast), network protocol to use, indication of |
| | device type, communication schedule, V2X service identifier and message type, |
| | transmission profile, and QoS parameters |
| Location reporting | For each UE identified in the policy, a corresponding configuration for reporting the |
| configuration | location of the UE, factoring the UE type, power source, remaining power, or the like. |
| | The configuration may comprise the frequency of reporting, the granularity of |
| | reporting, ranging information (e.g., relative distance to other UEs), or the like. |
| Temporal | The time periods for which the V2P detection is enabled; the time may be fixed, |
| constraints | periodic, on demand, location dependent, or the like. |
| Application server | A list of application servers that may assist with V2P detection based on the UE or |
| identifiers | vehicle location; the list may be used for making ACR/ACT decisions in conjunction |
| | with UE and vehicle location |
| Battery information | Information about how a UE is powered, whether it is a large size vehicle battery, |
| | medium size device battery, and small size (constraint) device battery. Other |
| | information about battery usage such as total battery capacity, battery level, discharge |
| | rate, and operating mode (e.g., normal, power saving, sleep, or the like) may be used to |
| | determine the device type and the transmission/reception capability of the device. |
| Application context | An indicator that specifies whether the reporting of application context on a UE is |
| reporting | enabled; the reporting may comprise of an application identifier or application type that |
| | is active on the UE. Additional context information related to the user's current |
| | interaction with one or more applications (e.g. simultaneous user activities such as |
| | typing, watching, and/or listening) may also be shared. Other application context |
| | information may be a user at or crossing a crosswalk, route of navigation application, |
| | user using attached device such as AR/VR glasses, or the like. This information may be |
| | used to indicate the activities performed by the user on the UE and to determine the |
| | attentiveness of the user or driver |
| Opportunistic | A list of conditions under which V2P communication may be used for delivery of other |
| critical information | critical information, e.g., from MNO, or the like. Such information, to be distributed |
| delivery conditions | via V2P communications, may be location-dependent with high granularity. |

We claim:

1. A method performed by a vehicle to everything (V2X) application enabler (VAE) client, the method comprising:
receiving a first request from an application client on a user equipment (UE) to enable vulnerable road user protection (VRUP) services associated with the UE;
sending a second request to a VAE server to create a vehicle to pedestrian (V2P) policy, wherein the V2P policy is configured to request creation of a vulnerable road user (VRU) zone associated with the UE;
receiving a first response to the second request indicating the status of the second request, the first response comprising information of the V2P policy that applies to the UE; and
sending a second response to the first request indicating the status of the first request.

2. The method of claim 1, wherein at least one of the first response or the second response comprises one or more of a status of the request, a policy identifier, a policy expiration, V2P status, information about the VRU zone, an indicator whether the VRU zone is dynamic, a V2X profile indicator, notification alert settings, V2P communication parameters, a location reporting configuration, temporary constraints, application server identifiers, application context reporting, battery information, or opportunistic critical information delivery conditions.

3. The method of claim 1, wherein the second request comprises at least one of the UE identifier, the UE location, an indication for creating a V2P policy, location reporting configuration of the UE, conditions for which to send the UE alerts, V2P communication parameters, temporal constraints for V2P detection, or an indication of whether the VRU zone is dynamic.

4. The method of claim 3, wherein the V2P communication parameters comprise at least one of authorization and authentication information, radio communication parameters, access type parameters, V2X identifiers, V2X communication identifiers, a mode of communication, V2P communication mechanisms, a communication schedule, a network protocol, a device type, a V2X service identifier and message type, a transmission profile, and QoS parameters.

5. The method of claim 1, further comprising receiving a vehicle to pedestrian notification from a VAE server.

6. The method of claim 5, wherein the VAE client sends a notification to an application client on the UE in response to receiving a vehicle to pedestrian notification from a VAE server.

7. The method of claim 1, wherein the VAE client receives a VRUP notification from an application on the UE with application context information.

8. The method of claim 7, further comprising the VAE client sending the application context information to a VAE server.

9. The method of claim 7, wherein the application context information comprises one or more of an application identifier, an indication that an application type is active on the UE, an indication that the UE is within a threshold distance of a crosswalk, a route of navigation associated with the application, or an indication that an additional device associated with the UE is in use.

10. A method performed by a vehicle to everything (V2X) application enabler (VAE) server, the method comprising:
receiving a first request from a VAE client on a user equipment (UE) to create a vehicle to pedestrian (V2P) policy, wherein the V2P policy is configured to request creation of a vulnerable road user (VRU) zone associated with the UE;
sending a message to a Vertical Application Specific Server (VASS) to determine authorization of the first request to create the V2P policy;
receiving a response from the VASS, the response comprising at least one of authorization information, V2P policy expiration information, one or more notification alert conditions, or V2P communication parameters;
configuring at least one of a location management or a data analytics subscription for the UE;
creating the V2P policy to enable V2P detection; and
sending a response to the first request comprising information associated with the V2P policy.

11. The method of claim 10, further comprising causing creation of a dynamic VRU zone associated with the UE.

12. The method of claim 11, wherein the UE is a first UE, further comprising:
receiving at least one of a notification of UE mobility, a data analytics prediction, or application context information;
causing updating of the dynamic VRU zone associated with the first UE; and
sending a notification to a second UE to at least one of alert of a potential collision or indicate V2P communication parameters for the second UE to communicate directly with the first UE.

13. The method of claim 10, wherein the first request comprises at least one of a UE identifier, a UE location, an indication for creating a V2P policy, a location reporting configuration of the UE, conditions for which to send the UE alerts, V2P communication parameters, temporal constraints for V2P detection, information associated with the creation of a VRU zone, or an indication of whether the VRU zone is dynamic.

14. The method of claim 10, wherein the V2P communication parameters comprise at least one of authorization and authentication information, radio communication parameters, access type parameters, V2X identifiers, V2X communication identifiers, a mode of communication, V2P communication mechanisms, a communication schedule, a network protocol, a device type, a V2X service identifier and message type, a transmission profile, and QoS parameters.

15. The method of claim 12, wherein the application context information comprises one or more of an application identifier, an indication that an application type is active on the first UE, an indication that the first UE is within a threshold distance of a crosswalk, a route of navigation associated with the application, or an indication that an additional device associated with the first UE is in use.
